(19) United States
(12) Patent Application Publication
(10) Pub. No.: US 2024/0406845 A1
(43) Pub. Date: Dec. 5, 2024

(54) METHOD AND DEVICE OF WIRELESS COMMUNICATION

(71) Applicant: GUANGDONG OPPO MOBILE TELECOMMUNICATIONS CORP., LTD., Dongguan (CN)

(72) Inventors: Pei ZHOU, Dongguan (CN); Lei HUANG, Singapore (SG)

(21) Appl. No.: 18/803,062

(22) Filed: Aug. 13, 2024

Related U.S. Application Data
(63) Continuation of application No. PCT/CN2022/076874, filed on Feb. 18, 2022.

(51) Int. Cl. H04W 48/08; H04B 7/024; H04B 7/06; H04W 84/12

(52) U.S. Cl. CPC H04W 48/08; H04B 7/024; H04B 7/0617; H04W 84/12

(57) ABSTRACT

A method of wireless communication includes: transmitting, by a first access point (AP), first information to at least one second AP, where the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the at least one second AP belong to the multi-AP coordinated set.

### CROSS-REFERENCE TO RELATED APPLICATION

This application is a Continuation application of International Application No. PCT/CN2022/076874 filed on Feb. 18, 2022, which is incorporated herein by reference in its entirety.

### TECHNICAL FIELD

Embodiments of the present disclosure relate to the field of communication, and in particular, to a method and a device of wireless communication.

### BACKGROUND

In some scenarios, a multi-access point (Access Point, AP) coordinated transmission technology of a coordinated beamforming (C-BF) mode is introduced. The C-BF is that multiple APs transmit or align useful signals to a target station (STATION, STA) by a method of beamforming, while transmitting or aligning nulls to an STA of overlapping basic service set (OBSS), to achieve interference suppression and improve signal to interference plus noise ratio (SINR) of the communication link, thereby improving throughput and reducing communication latency. Therefore, how to calculate a steering matrix for the C-BF to achieve effective interference suppression is an urgent problem to be solved.

### SUMMARY

The present disclosure provides a method and a device of wireless communication.

In a first aspect, a method of wireless communication is provided, including: transmitting, by a first access point (AP), first information to at least one second AP, where the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the at least one second AP belong to the multi-AP coordinated set.

In a second aspect, a method of wireless communication is provided, including: receiving, by a second access point (AP), first information transmitted by a first AP, where the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the second AP belong to the multi-AP coordinated set.

In a third aspect, an access point is provided, configured to perform the method in the above first aspect or its various implementations.

Exemplarily, the access point includes a functional module for performing the method in the above first aspect or its various implementations.

In a fourth aspect, an access point is provided, configured to perform the method in the above second aspect or its various implementations.

Exemplarily, the access point includes a functional module for performing the method in the above second aspect or its various implementations.

In a fifth aspect, an access point is provided, including a processor and a memory. The memory is used to store a computer program, and the processor is used to invoke and execute the computer program stored in the memory, to perform the method in the above first aspect or its various implementations.

In a sixth aspect, an access point is provided, including a processor and a memory. The memory is used to store a computer program, and the processor is used to invoke and execute the computer program stored in the memory, to perform the method in the above second aspect or its various implementations.

In a seventh aspect, a chip is provided for implementing the method in any one of the above first aspect to the above second aspect or their various implementations.

Exemplarily, the chip includes: a processor, configured to invoke and execute a computer program from a memory, to cause a device equipped with the apparatus to perform the method in any one of the above first aspect to the above second aspect or their various implementations.

In an eighth aspect, a computer-readable storage medium is provided for storing a computer program, and the computer program causes a computer to perform the method in any one of the above first aspect to the above second aspect or their various implementations.

In a ninth aspect, a computer program product is provided, including computer program instructions, and the computer program instructions cause a computer to perform the method in any one of the above first aspect to the above second aspect or their various implementations.

In a tenth aspect, a computer program is provided, and the computer program, when being executed on a computer, causes the computer to perform the method in any one of the above first aspect to the above second aspect or their various implementations.

### BRIEF DESCRIPTION OF THE DRAWINGS

FIG. 1 is a schematic diagram of a communication system architecture, provided in the embodiments of the present disclosure.

FIG. 2A is a schematic diagram of a wired multi-AP coordinated architecture, applicable according to the embodiments of the present disclosure.

FIG. 2B is a schematic diagram of another wired multi-AP coordinated architecture, applicable according to the embodiments of the present disclosure.

FIG. 3 is a schematic diagram of a wireless multi-AP coordinated architecture, applicable according to the embodiments of the present disclosure.

FIG. 4 is a schematic diagram of C-BF, provided according to the embodiments of the present disclosure.

FIG. 5 is a flow chart of channel sounding of C-BF, provided according to the embodiments of the present disclosure.

FIG. 6 is a schematic interaction diagram of a method of wireless communication, provided in the embodiments of the present disclosure.

FIG. 7 is a schematic diagram of a frame format of a coordinated transmission announce frame, provided in the embodiments of the present disclosure.

FIG. 8 is a schematic format diagram of a coordinated transmission (TX) scheme adopted field in the coordinated transmission announce frame shown in FIG. 7.

FIG. 9 is a schematic format diagram of a C-BF parameters field in the coordinated transmission announce frame shown in FIG. 7.

FIG. 10 is a schematic interaction diagram of a preparation phase, provided in the embodiments of the present disclosure.

FIG. 11 is a schematic interaction diagram of another preparation phase, provided in the embodiments of the present disclosure.

FIG. 12 is a schematic diagram of a frame format of a coordinated transmission request frame, provided in the embodiments of the present disclosure.

FIG. 13 is a schematic diagram of a frame format of a coordinated transmission response frame, provided in the embodiments of the present disclosure.

FIG. 14 is a schematic format diagram of a coordinated TX scheme accept field in the coordinated transmission response frame shown in FIG. 13.

FIG. 15 is a schematic format diagram of a C-BF information field in the coordinated transmission response frame shown in FIG. 13.

FIG. 16 is a schematic interaction diagram of a multi-AP coordinated transmission process, according to an embodiment of the present disclosure.

FIG. 17 is a schematic interaction diagram of carrying first information by a coordinated transmission trigger frame, provided in the embodiments of the present disclosure.

FIG. 18 is another schematic interaction diagram of carrying first information by a coordinated transmission trigger frame, provided in the embodiments of the present disclosure.

FIG. 19 is a schematic block diagram of an access point, provided in the embodiments of the present disclosure.

FIG. 20 is a schematic block diagram of another access point, provided in the embodiments of the present disclosure.

FIG. 21 is a schematic block diagram of a communication device, provided in the embodiments of the present disclosure.

FIG. 22 is a schematic block diagram of a chip, provided in the embodiments of the present disclosure.

FIG. 23 is a schematic block diagram of a communication system, provided in the embodiments of the present disclosure.

### DETAILED DESCRIPTION

The technical solutions of the embodiments of the present disclosure will be described below, in conjunction with the drawings in the embodiments of the present disclosure. Obviously, the described embodiments are merely some but not all of the embodiments of the present disclosure. All other embodiments obtained based on the embodiments of the present disclosure by the ordinary skilled in the art shall belong to the protection scope of the present disclosure.

The technical solutions of the embodiments of the present disclosure may be applied to various communication systems, such as wireless local area network (WLAN), wireless fidelity (WiFi) or other communication systems, etc.

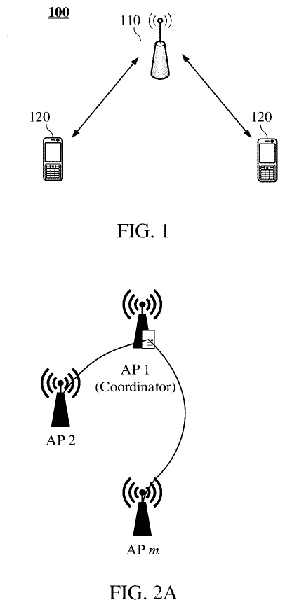

For example, a communication system 100 applied in the embodiments of the present disclosure is shown in FIG. 1. The communication system 100 may include an access point (AP) 110 and stations (STATIONs, STAs) 120 which access a network by the access point 110.

In some scenarios, an AP may also be referred to as an AP STA. That is, in a sense, the AP is also a kind of STA.

In some scenarios, an STA is also referred to as a non-AP STA.

The communication in the communication system 100 may be a communication between an AP and a non-AP STA, a communication between a non-AP STA and a non-AP STA, or a communication between an STA and a peer STA. The peer STA may refer to a device that has a peer communication with the STA. For example, the peer STA may be an AP or a non-AP STA.

The AP is the equivalent of a bridge connecting a wired network and a wireless network, whose main role is to connect various wireless network clients together and then access the wireless network to Ethernet. The AP device may be a terminal device (e.g., a mobile phone) or network device (e.g., router) with a WiFi chip.

It should be understood that a role of the STA in the communication system is not absolute. For example, in some scenarios, in a case where a mobile phone is connected to a router, the mobile phone is the non-AP STA, and in a case where the mobile phone serves as a hotspot for other mobile phones, the mobile phone acts as the AP.

The AP and the non-AP STA may be devices applied in Vehicle to Everything, Internet of Things (IoT) nodes, sensors, etc., in IoT, smart cameras, smart remote controllers, smart watermeters, smart electricity meters, etc., in a smart home, and sensors in a smart city, etc.

In some embodiments, the non-AP STA may support an 802.11be standard. The non-AP STA may also support various wireless local area network (WLAN) standards of the current and future 802.11 family, such as 802.11ax, 802.11ac, 802.11n, 802.11g, 802.11b and 802.11a, etc.

In some embodiments, the AP may be a device supporting the 802.11be standard. The AP may also be a device supporting various WLAN standards of the current and future 802.11 family, such as 802.11ax, 802.11ac, 802.11n, 802.11g, 802.11b, and 802.11a, etc.

In the embodiments of the present disclosure, the STA may be a mobile phone, a pad, a computer, a virtual reality (VR) device, an augmented reality (AR) device, a wireless device in industrial control, a set-top box, a wireless device in self driving, a vehicle-mounted communication device, a wireless device in remote medical, a wireless device in smart grid, a wireless device in transportation safety, a wireless device in smart city, a wireless device in smart home, a wireless communication chip/application-specific integrated circuit (ASIC)/system on chip (SoC), or the like, which support the WLAN/WiFi technology.

Frequency bands that the WLAN technology may support may include, but are not limited to: low frequency bands (e.g., 2.4 GHZ, 5 GHZ, 6 GHZ), high frequency bands (e.g., 60 GHz).

FIG. 1 exemplarily shows one AP STA and two non-AP STAs. Optionally, the communication system 100 may include multiple AP STAs and other numbers of non-AP STAs, which are not limited to the embodiments of the present disclosure.

It should be understood that a device with a communication function in the network/system in the embodiments of the present disclosure may be referred to as a communication device. In an example of the communication system 100 shown in FIG. 1, the communication devices may include an access point 110 and stations 120 with the communication function. The access point 110 and the stations 120 may be specific devices described above and will not be repeated here. The communication devices may also include other devices in the communication system 100, such as a network controller, a gateway and other network entities, which are not limited to the embodiments of the present disclosure.

It should be understood that terms herein “system” and “network” are often used interchangeably herein. The term “and/or” herein is only an association relationship to describe associated objects, indicating that there may be three relationships, for example, “A and/or B” may indicate three cases of: A alone, both A and B, and B alone. In addition, the character “/” herein generally indicates that associated objects before and after this character are in an “or” relationship.

It should be understood that the “indication” mentioned in the embodiments of the present disclosure may be a direct indication or an indirect indication, or may represent that there is an association relationship. For example, A indicating B may mean that A directly indicates B, e.g., that B may be obtained by A; or it may mean that A indirectly indicates B, e.g., that A indicates C, and B may be obtained by C; or it may mean that there is an association relationship between A and B.

In the description of the embodiments of the present disclosure, the term “corresponding” may mean a direct or indirect corresponding relationship between the two, or an association relationship between the two, or a relationship of indicating and being indicated, or configuring and being configured, etc.

In the embodiments of the present disclosure, “predefined” may be implemented by pre-saving corresponding codes, tables or other manners that may be used for indicating related information, in the device (for example, including the access point and the station), and the present disclosure does not limit its specific implementation. For example, the predefined may mean defined in a protocol.

In the embodiments of the present disclosure, the “protocol” may refer to a standard protocol in the field of communication, which may include, for example, a WiFi protocol, and related protocols applied in the future WiFi communication system, and the present disclosure is not limited thereto.

To facilitate the understanding of the technical solutions of the embodiments of the present disclosure, establishment of a multi-AP coordinated set related to the present disclosure is described below.

The establishment of the multi-AP coordinated set includes the following two phases: a multi-AP coordinated capability discovery phase and a multi-AP coordinated set establishment phase.

In the multi-AP coordinated capability discovery phase, an AP, by receiving a beacon frame or other management frames transmitted by a neighbor AP, may discover multi-AP coordinated capabilities of each other.

In the multi-AP coordinated set establishment phase, an AP that initiates a multi-AP coordinated transmission is referred to as a master AP (MAP), and the MAP selects a slave AP (SAP) (one or more SAPs) around it to participate in the multi-AP coordinated transmission. In this process, MAP and SAP will interact with each other with some information for configuring the multi-AP coordinated set, and the specific steps and interacted information are as follows:
1) transmitting, by the MAP, a request frame to SAPs, which mainly includes the following information: assigning identities (IDs) of the SAPs during the multi-AP coordinated transmission, and assigning an ID of the multi-AP coordinated set;
2) replying, by the SAPs, to the MAP with a response frame, which mainly includes the following information: information of STAs associated with the SAP, including the STAs' IDs and capability information of participating in the multi-AP coordinated transmission; and priorities of the STAs participating in the multi-AP coordinated transmission.

APs participating in the multi-AP coordinated transmission may include the following roles:
MAP (Master AP), SAP (Slave AP), Coordinating AP, Coordinated AP, sharing AP, and shared AP.

Herein, in the multi-AP coordinated set establishment phase, the AP in the MAP role initiates a request for the multi-AP coordinated set establishment to the AP in the SAP role; in a channel sounding phase, the coordinating AP in the coordinating AP role initiates channel sounding, and the AP in the coordinated AP role participates in the channel sounding; in a preparation phase and/or a coordinated transmission phase, the AP in the sharing AP role shares its transmission opportunity (TXOP) resource with the AP in the shared AP role, for the coordinated transmission.

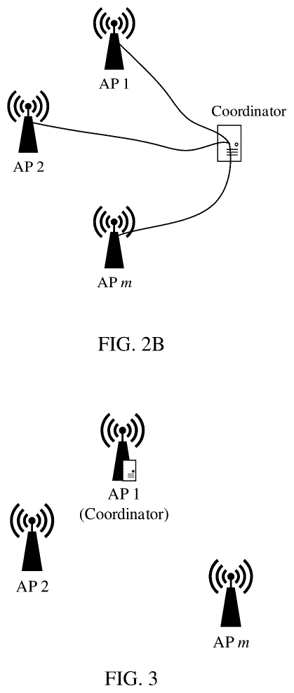

In some embodiments, the present disclosure may be applied to wired multi-AP coordinated transmission architectures as shown in FIG. 2A and FIG. 2B, or may be applied to a wireless multi-AP coordinated transmission architecture as shown in FIG. 3.

In the wired multi-AP coordinated transmission architecture, as shown in FIG. 2A, a coordinator in the network is in a certain AP and controls other APs by a wired connection; as shown in FIG. 2B, there is an independent coordinator in the network that controls other APs by a wired connection. For the wired multi-AP coordinated transmission architecture, the multi-AP coordinated set establishment is set by a network operator directly at a controller.

In the wireless multi-AP coordinated transmission architecture, a coordinator in the network is in a certain AP (called MAP) and controls other APs (called SAPs) wirelessly.

To facilitate the understanding of the technical solutions of the embodiments of the present disclosure, coordinated beamforming (C-BF) related to the present disclosure is described below.

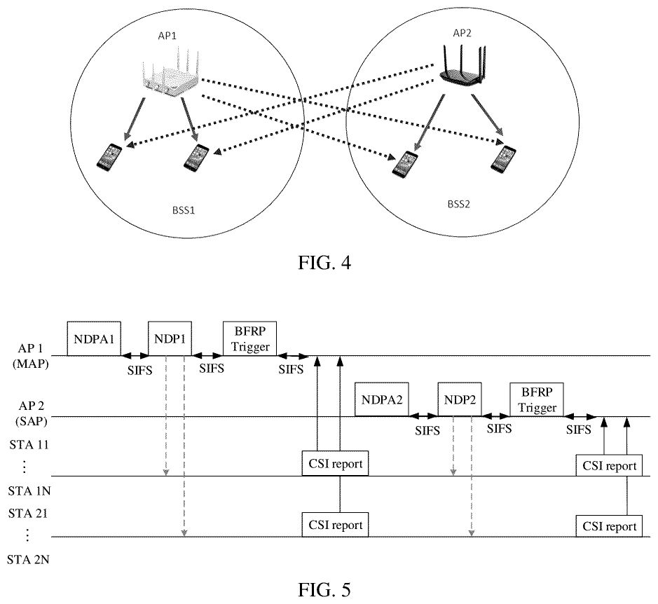

802.11be introduces the multi-AP coordinated transmission technology in the C-BF mode. The C-BF is that multiple APs transmit or align useful signals to a target STA by the method of beamforming, while transmitting or aligning nulls to an STA of the overlapping basic service set (OBSS), and thus, interference suppression may be achieved and the signal to interference plus noise ratio (SINR) of the communication link may be improved, thereby improving throughput and reducing communication latency. As shown in FIG. 4, solid lines represent the useful signals transmitted by the AP, and dotted lines represent the nulls transmitted by the AP.

To facilitate the understanding of the technical solutions of the embodiments of the present disclosure, information interaction in the channel sounding phase related to the present disclosure is described below.

In some embodiments, multiple APs in the multi-AP coordinated set may perform sequential channel sounding.

For example, multiple APs sequentially transmit null data physical layer protocol data unit (Null Data PPDU, NDP) to associated STAs and non-associated OBSS STAs for the channel sounding. Each AP collects channel sounding results, namely, channel state information (CSI), by transmitting a beamforming report poll (BFRP) trigger frame. Both associated STAs and OBSS STAs may feedback the channel sounding results.

As shown in FIG. 5, the multi-AP coordinated set includes AP1 and AP2, the AP1 is an MAP, the AP2 is an SAP. The AP1 is associated with STAn to STAIN, and the AP2 is associated with STA₂₁ to STA_{2N}. In the channel sounding phase, the AP1 transmits an NDP Announcement (NDPA) 1 frame to announce that it will transmit an NDP, and transmits an NDP1 frame after a short interframe space (SIFS). The STAs associated with the AP1 and the AP2 receive the NDP1 frame and obtain the channel sounding result. The AP1 transmits a BFRP Trigger frame to trigger the AP1, the AP2 and their associated STAs to report the channel sounding results. Then, the AP2 transmits an NDPA2 frame to announce that it will transmit an NDP, and transmits an NDP2 frame after an SIFS. The STAs associated with the AP1 and the AP2 receive the NDP2 frame and obtain the channel sounding results. The AP2 transmits a BFRP trigger frame to trigger the STAs associated with the AP1 and the AP2 to report the channel sounding results.

An AP in the multi-AP coordinated set performing the multi-AP coordinated transmission first needs to calculate a steering matrix. Exemplarily, the AP may calculate the steering matrix for the multi-AP coordinated transmission according to the collected channel sounding results.

However, in practical applications, after completing the channel sounding, an SAP in the multi-AP coordinated set may not participate in the multi-AP coordinated transmission due to some reasons (such as the channel state being busy). Calculating the steering matrix based on all the collected channel sounding results will cause performance loss. Therefore, how to calculate the steering matrix for the multi-AP coordinated transmission is an urgent problem to be solved.

To facilitate the understanding of the technical solutions of the embodiments of the present disclosure, the technical solutions of the present disclosure are described in detail below by specific embodiments. The following related technologies as optional solutions, may be arbitrarily combined with the technical solutions of the embodiments of the present disclosure, and they all belong to the protection scope of the embodiments of the present disclosure. The embodiments of the present disclosure include at least a part of the following content.

The embodiments of the present disclosure provide a method of wireless communication, and the method includes:
transmitting, by a first access point (AP), first information to at least one second AP, where the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the at least one second AP belong to the multi-AP coordinated set.

In some embodiments, the first information is used to indicate at least one of:
at least one AP, where the at least one AP includes an AP in the multi-AP coordinated set and participating in the multi-AP coordinated transmission in the C-BF mode, and/or an AP in the multi-AP coordinated set and not participating in the multi-AP coordinated transmission in the C-BF mode; or
at least one STA set, where each STA set corresponds to an AP participating in the multi-AP coordinated transmission in the C-BF mode, and each STA set includes STAs that participate in the multi-AP coordinated transmission in the C-BF mode among STAs associated with a corresponding AP, and/or STAs that do not participate in the multi-AP coordinated transmission in the C-BF mode among STAs associated with a corresponding AP.

In some embodiments, the at least one STA set is indicated by a bitmap.

In some embodiments, the first information includes:
at least one associated STA list, where each associated STA list corresponds to an AP participating in the multi-AP coordinated transmission in the C-BF mode, and each associated STA list is used to indicate a list of STAs associated with a corresponding AP; and
at least one C-BF bitmap, where each C-BF bitmap corresponds to an AP participating in the multi-AP coordinated transmission in the C-BF mode, and each C-BF bitmap is used to indicate STAs participating in the multi-AP coordinated transmission in the C-BF mode and/or STAs not participating in the multi-AP coordinated transmission in the C-BF mode, in a list of STAs associated with a corresponding AP.

In some embodiments, the first information includes at least one STA list participating in C-BF, each STA list participating in the C-BF corresponds to an AP participating in the multi-AP coordinated transmission in the C-BF mode, and the STA list participating in the C-BF is used to indicate STAs participating in the multi-AP coordinated transmission in the C-BF mode and associated with a corresponding AP.

In some embodiments, the first information further includes first indication information, and the first indication information is used to indicate the multi-AP coordinated transmission adopting the C-BF mode.

In some embodiments, the first information is carried in a first frame, the first frame includes a coordinated transmission announce field, and the coordinated transmission announce field is used to carry the first information.

In some embodiments, the coordinated transmission announce field includes at least one of the following fields:
a coordinated transmission (TX) scheme adopted field, to indicate a mode adopted to perform the multi-AP coordinated transmission;
a C-BF parameters field, to indicate parameters adopted to perform the multi-AP coordinated transmission in the C-BF mode;
a coordinated orthogonal frequency division multiple access (C-OFDMA) parameters field, to indicate parameters adopted to perform the multi-AP coordinated transmission in a C-OFDMA mode;
a coordinated spatial reuse (C-SR) parameters field, to indicate parameters adopted to perform the multi-AP coordinated transmission in a C-SR mode;
a joint transmission (J-TX) parameters field, to indicate parameters adopted to perform the multi-AP coordinated transmission in a J-TX mode; or a coordinated uplink multiple user multiple input multiple output (C-UL MU MIMO) parameters field, to indicate parameters adopted to perform the multi-AP coordinated transmission in a C-UL MU MIMO mode.

In some embodiments, the C-BF parameters field includes at least one of the following fields:
a number of APs field, to indicate the number of APs included in the first frame;
at least one AP identification (ID) field, where each AP ID field indicates an AP participating in the multi-AP coordinated transmission in the C-BF mode and/or an AP not participating in the multi-AP coordinated transmission in the C-BF mode;
at least one associated STA list field, where each associated STA list field corresponds to an AP indicated by the at least one AP ID field, and the associated STA list field is used to indicate a list of STAs associated with a corresponding AP; or
at least one C-BF bitmap field, where each C-BF bitmap field corresponds to an AP indicated by the at least one AP ID field, and the C-BF bitmap field is used to indicate whether STAs in a list of STAs associated with a corresponding AP participate in the multi-AP coordinated transmission in the C-BF mode.

In some embodiments, the C-BF parameters field includes at least one of the following fields:
a number of APs field, to indicate the number of APs included in the first frame;
at least one AP ID field, to indicate at least one AP participating in the multi-AP coordinated transmission in the C-BF mode; or
at least one STA list participating in C-BF field, where each STA list participating in C-BF field corresponds to an AP indicated by the at least one AP ID field, and the STA list participating in C-BF field is used to indicate STAs associated with a corresponding AP and participating in the multi-AP coordinated transmission in the C-BF mode.

In some embodiments, the coordinated TX scheme adopted field includes at least one of the following fields:
a C-BF adopted field, to indicate whether the multi-AP coordinated transmission in the C-BF mode is adopted;
a C-OFDMA adopted field, to indicate whether the multi-AP coordinated transmission in the C-OFDMA mode is adopted;
a C-SR adopted field, to indicate whether the multi-AP coordinated transmission in the C-SR mode is adopted;
a J-TX adopted field, to indicate whether the multi-AP coordinated transmission in the J-TX mode is adopted; or
a C-UL MU MIMO adopted field, to indicate whether the multi-AP coordinated transmission in the C-UL MU MIMO mode is adopted.

In some embodiments, the first frame is further used to trigger an AP participating in the multi-AP coordinated transmission in the C-BF mode to perform the multi-AP coordinated transmission in the C-BF mode.

In some embodiments, the method further includes:
transmitting, by the first AP, first request information to at least one third AP, where the first request information is used to request the at least one third AP to participate in the multi-AP coordinated transmission in the C-BF mode, and the at least one third AP belongs to the multi-AP coordinated set.

In some embodiments, the at least one third AP includes the at least one second AP.

In some embodiments, the first request information includes second indication information, and the second indication information is used to indicate a coordinated transmission mode in which the first AP requests to participate.

In some embodiments, the first request information is carried in a second frame, the second frame includes a coordinated transmission request field, and the coordinated transmission request field is used to carry the first request information.

In some embodiments, the coordinated transmission request field includes at least one of the following fields:
a coordinated TX scheme used field, to indicate a coordinated transmission mode requested to be used;
a C-BF command field, to indicate a command used when the multi-AP coordinated transmission in the C-BF mode is adopted;
a C-OFDMA command field, to indicate a command used when the multi-AP coordinated transmission in a C-OFDMA mode is adopted;
a C-SR command field, to indicate a command used when the multi-AP coordinated transmission in a C-SR mode is adopted;
a J-TX command field, to indicate a command used when the multi-AP coordinated transmission in a J-TX mode is adopted; or
a C-UL MU MIMO command field, to indicate a command used when the multi-AP coordinated transmission in a C-UL MU MIMO mode is adopted.

In some embodiments, the coordinated TX scheme used field includes at least one of the following fields:
a C-BF used field, to indicate whether to request to use the multi-AP coordinated transmission in the C-BF mode;
a C-OFDMA used field, to indicate whether to request to use the multi-AP coordinated transmission in the C-OFDMA mode;
a C-SR used field, to indicate whether to request to use the multi-AP coordinated transmission in the C-SR mode;
a J-TX used field, to indicate whether to request to use the multi-AP coordinated transmission in the J-TX mode; or
a C-UL MU MIMO used field, to indicate whether to request to use the multi-AP coordinated transmission in the C-UL MU MIMO mode.

In some embodiments, where transmitting, by the first AP, the first request information to the at least one third AP, includes:
transmitting, by the first AP, the first request information to the at least one third AP by broadcasting or multicasting; or
transmitting, by the first AP, the first request information to the at least one third AP by unicasting.

In some embodiments, the method further includes:
receiving, by the first AP, first response information transmitted by the at least one third AP, where the first response information is used to indicate whether the third AP participates in the multi-AP coordinated transmission in the C-BF mode and/or whether a STA associated with the third AP participates in the multi-AP coordinated transmission in the C-BF mode.

In some embodiments, where receiving, by the first AP, the first response information transmitted by the at least one third AP, includes:
receiving, by the first AP, the first response information transmitted synchronously by the at least one third AP; or
receiving, by the first AP, the first response information transmitted asynchronously by the at least one third AP.

In some embodiments, the first response information includes an associated STA list and a C-BF bitmap, the associated STA list is a list of STAs associated with the third AP, and the C-BF bitmap is used to indicate whether each STA in the list of STAs associated with the third AP participates in the multi-AP coordinated transmission in the C-BF mode.

In some embodiments, the first response information includes an STA list participating in C-BF, and the STA list participating in the C-BF is a list of STAs associated with the third AP and participating in the multi-AP coordinated transmission in the C-BF mode.

In some embodiments, the first response information further includes third indication information, and the third indication information is used to indicate a coordinated transmission mode accepted by the third AP.

In some embodiments, the first response information is carried in a third frame, the third frame includes a coordinated transmission response field, and the coordinated transmission response field is used to carry the first response information.

In some embodiments, the coordinated transmission response field includes at least one of the following fields:
a coordinated TX scheme accept field, to indicate whether the third AP accepts a requested coordinated transmission mode;
a C-BF information field, to indicate information related to the third AP with C-BF;
a C-OFDMA information field, to indicate information related to the third AP with C-OFDMA;
a C-SR information field, to indicate information related to the third AP with C-SR;
a J-TX information field, to indicate information related to the third AP with J-TX; or
a C-UL MU MIMO information field, to indicate information related to the third AP with C-UL MU MIMO.

In some embodiments, the C-BF information field includes at least one of the following fields:
an associated STA list field, to indicate a list of STAs associated with the third AP; or
a C-BF bitmap of associated STAs field, to indicate whether each STA in the list of STAs associated with the third AP participates in the multi-AP coordinated transmission in the C-BF mode.

In some embodiments, the C-BF information field includes an STA list participating in C-BF field, which is used to indicate STAs associated with the third AP and participating in the multi-AP coordinated transmission in the C-BF mode.

In some embodiments, the coordinated TX scheme accept field includes at least one of the following fields:
a C-BF accept field, to indicate whether the multi-AP coordinated transmission in a C-BF mode is accepted;
a C-OFDMA accept field, to indicate whether the multi-AP coordinated transmission in a C-OFDMA mode is accepted;
a C-SR accept field, to indicate whether the multi-AP coordinated transmission in a C-SR mode is accepted;
a J-TX accept field, to indicate whether the multi-AP coordinated transmission in a J-TX mode is accepted; or
a C-UL MU MIMO accept field, to indicate whether the coordinated transmission in a C-UL MU MIMO mode is accepted.

In some embodiments, the at least one second AP is an AP in the multi-AP coordinated set and participating in the multi-AP coordinated transmission in the C-BF mode.

In some embodiments, the first AP is a sharing AP, and the at least one second AP is a shared AP.

In some embodiments, the first AP is a master AP and the at least one second AP is a slave AP.

The embodiments of the present disclosure provide a method of wireless communication, and the method includes:
receiving, by a second access point (AP), first information transmitted by a first AP, where the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the second AP belong to the multi-AP coordinated set.

In some embodiments, the first information is used to indicate at least one of:
at least one AP, where the at least one AP includes an AP in the multi-AP coordinated set and participating in the multi-AP coordinated transmission in the C-BF mode, and/or an AP in the multi-AP coordinated set and not participating in the multi-AP coordinated transmission in the C-BF mode; or
at least one STA set, where each STA set corresponds to an AP participating in the multi-AP coordinated transmission in the C-BF mode, and each STA set includes STAs that participate in the multi-AP coordinated transmission in the C-BF mode among STAs associated with a corresponding AP, and/or STAs that do not participate in the multi-AP coordinated transmission in the C-BF mode among STAs associated with a corresponding AP.

In some embodiments, the at least one STA set is indicated by a bitmap.

In some embodiments, the first information includes:
at least one associated STA list, where each associated STA list corresponds to an AP participating in the multi-AP coordinated transmission in the C-BF mode, and each associated STA list is used to indicate a list of STAs associated with a corresponding AP; and
at least one C-BF bitmap, where each C-BF bitmap corresponds to an AP participating in the multi-AP coordinated transmission in the C-BF mode, and each C-BF bitmap is used to indicate STAs participating in the multi-AP coordinated transmission in the C-BF mode and/or STAs not participating in the multi-AP coordinated transmission in the C-BF mode, in a list of STAs associated with a corresponding AP.

In some embodiments, the first information includes at least one STA list participating in C-BF, each STA list participating in the C-BF corresponds to an AP participating in the multi-AP coordinated transmission in the C-BF mode, and the STA list participating in the C-BF is used to indicate STAs participating in the multi-AP coordinated transmission in the C-BF mode and associated with a corresponding AP.

In some embodiments, the first information further includes first indication information, and the first indication information is used to indicate the multi-AP coordinated transmission adopting the C-BF mode.

In some embodiments, the first information is carried in a first frame, the first frame includes a coordinated transmission announce field, and the coordinated transmission announce field is used to carry the first information.

In some embodiments, the coordinated transmission announce field includes at least one of the following fields:
a coordinated transmission (TX) scheme adopted field, to indicate a mode adopted to perform the multi-AP coordinated transmission;
a C-BF parameters field, to indicate parameters adopted to perform the multi-AP coordinated transmission in the C-BF mode;
a coordinated orthogonal frequency division multiple access (C-OFDMA) parameters field, to indicate parameters adopted to perform the multi-AP coordinated transmission in a C-OFDMA mode;
a coordinated spatial reuse (C-SR) parameters field, to indicate parameters adopted to perform the multi-AP coordinated transmission in a C-SR mode;
a joint transmission (J-TX) parameters field, to indicate parameters adopted to perform the multi-AP coordinated transmission in a J-TX mode; or
a coordinated uplink multiple user multiple input multiple output (C-UL MU MIMO) parameters field, to indicate parameters adopted to perform the multi-AP coordinated transmission in a C-UL MU MIMO mode.

In some embodiments, the C-BF parameters field includes at least one of the following fields:
a number of APs field, to indicate the number of APs included in the first frame;
at least one AP identification (ID) field, where each AP ID field indicates an AP participating in the multi-AP coordinated transmission in the C-BF mode and/or an AP not participating in the multi-AP coordinated transmission in the C-BF mode;
at least one associated STA list field, where each associated STA list field corresponds to an AP indicated by the at least one AP ID field, and the associated STA list field is used to indicate a list of STAs associated with a corresponding AP; or
at least one C-BF bitmap field, where each C-BF bitmap field corresponds to an AP indicated by the at least one AP ID field, and the C-BF bitmap field is used to indicate whether STAs in a list of STAs associated with a corresponding AP participate in the multi-AP coordinated transmission in the C-BF mode.

In some embodiments, the C-BF parameters field includes at least one of the following fields:
a number of APs field, to indicate the number of APs included in the first frame;
at least one AP ID field, to indicate at least one AP participating in the multi-AP coordinated transmission in the C-BF mode; or
at least one STA list participating in C-BF field, where each STA list participating in C-BF field corresponds to an AP indicated by the at least one AP ID field, and the STA list participating in C-BF field is used to indicate STAs associated with a corresponding AP and participating in the multi-AP coordinated transmission in the C-BF mode.

In some embodiments, the coordinated TX scheme adopted field includes at least one of the following fields:
a C-BF adopted field, to indicate whether the multi-AP coordinated transmission in the C-BF mode is adopted;
a C-OFDMA adopted field, to indicate whether the multi-AP coordinated transmission in the C-OFDMA mode is adopted;
a C-SR adopted field, to indicate whether the multi-AP coordinated transmission in the C-SR mode is adopted;
a J-TX adopted field, to indicate whether the multi-AP coordinated transmission in the J-TX mode is adopted; or
a C-UL MU MIMO adopted field, to indicate whether the multi-AP coordinated transmission in the C-UL MU MIMO mode is adopted.

In some embodiments, the first frame is further used to trigger an AP participating in the multi-AP coordinated transmission in the C-BF mode to perform the multi-AP coordinated transmission in the C-BF mode.

In some embodiments, the method further includes:
receiving, by the second AP, first request information transmitted by the first AP, where the first request information is used to request the second AP to participate in the multi-AP coordinated transmission in the C-BF mode.

In some embodiments, the first request information includes second indication information, and the second indication information is used to indicate a coordinated transmission mode in which the first AP requests to participate.

In some embodiments, the first request information is carried in a second frame, the second frame includes a coordinated transmission request field, and the coordinated transmission request field is used to carry the first request information.

In some embodiments, the coordinated transmission request field includes at least one of the following fields:
a coordinated TX scheme used field, to indicate a coordinated transmission mode requested to be used;
a C-BF command field, to indicate a command used when the multi-AP coordinated transmission in the C-BF mode is adopted;
a C-OFDMA command field, to indicate a command used when the multi-AP coordinated transmission in a C-OFDMA mode is adopted;
a C-SR command field, to indicate a command used when the multi-AP coordinated transmission in a C-SR mode is adopted;
a J-TX command field, to indicate a command used when the multi-AP coordinated transmission in a J-TX mode is adopted; or
a C-UL MU MIMO command field, to indicate a command used when the multi-AP coordinated transmission in a C-UL MU MIMO mode is adopted.

In some embodiments, the coordinated TX scheme used field includes at least one of the following fields:
a C-BF used field, to indicate whether to request to use the multi-AP coordinated transmission in the C-BF mode;
a C-OFDMA used field, to indicate whether to request to use the multi-AP coordinated transmission in the C-OFDMA mode;
a C-SR used field, to indicate whether to request to use the multi-AP coordinated transmission in the C-SR mode;
a J-TX used field, to indicate whether to request to use the multi-AP coordinated transmission in the J-TX mode; or
a C-UL MU MIMO used field, to indicate whether to request to use the multi-AP coordinated transmission in the C-UL MU MIMO mode.

In some embodiments, where receiving, by the second AP, the first request information transmitted by the first AP, includes:
receiving, by the second AP, the first request information transmitted by the first AP by broadcasting or multicasting; or
receiving, by the second AP, the first request information transmitted by the first AP by unicasting.

In some embodiments, the method further includes:
transmitting, by the second AP, first response information to the first AP, where the first response information is used to indicate whether the second AP participates in the multi-AP coordinated transmission in the C-BF mode and/or whether an STA associated with the second AP participates in the multi-AP coordinated transmission in the C-BF mode.

In some embodiments, the first response information includes an associated STA list and a C-BF bitmap, the associated STA list is a list of STAs associated with the second AP, and the C-BF bitmap is used to indicate whether each STA in the list of STAs associated with the second AP participates in the multi-AP coordinated transmission in the C-BF mode.

In some embodiments, the first response information includes an STA list participating in C-BF, and the STA list participating in the C-BF is a list of STAs associated with the second AP and participating in the multi-AP coordinated transmission in the C-BF mode.

In some embodiments, the first response information further includes third indication information, and the third indication information is used to indicate a coordinated transmission mode accepted by the second AP.

In some embodiments, the first response information is carried in a third frame, the third frame includes a coordinated transmission response field, and the coordinated transmission response field is used to carry the first response information.

In some embodiments, the coordinated transmission response field includes at least one of the following fields:
a coordinated TX scheme accept field, to indicate a coordinated transmission mode accepted by the second AP;
a C-BF information field, to indicate information related to the second AP with C-BF;
a C-OFDMA information field, to indicate information related to the second AP with C-OFDMA;
a C-SR information field, to indicate information related to the second AP with C-SR;
a J-TX information field, to indicate information related to the second AP with J-TX; or
a C-UL MU MIMO information field, to indicate information related to the second AP with C-UL MU MIMO.

In some embodiments, the C-BF information field includes at least one of the following fields:
an associated STA list field, to indicate a list of STAs associated with the second AP; or
a C-BF bitmap of associated STAs field, to indicate whether each STA in the list of STAs associated with the second AP participates in the multi-AP coordinated transmission in the C-BF mode.

In some embodiments, the C-BF information field includes an STA list participating in C-BF field, which is used to indicate STAs associated with the second AP and participating in the multi-AP coordinated transmission in the C-BF mode.

In some embodiments, the coordinated TX Scheme accept field includes at least one of the following fields:
a C-BF accept field, to indicate whether the multi-AP coordinated transmission in a C-BF mode is accepted;
a C-OFDMA accept field, to indicate whether the multi-AP coordinated transmission in a C-OFDMA mode is accepted;
a C-SR accept field, to indicate whether the multi-AP coordinated transmission in a C-SR mode is accepted;
a J-TX accept field, to indicate whether the multi-AP coordinated transmission in a J-TX mode is accepted; or
a C-UL MU MIMO accept field, to indicate whether the coordinated transmission in a C-UL MU MIMO mode is accepted.

In some embodiments, the method further includes:
determining, by the second AP, target channel state information among pre-stored channel state information according to the first information; and
calculating a steering matrix for the multi-AP coordinated transmission in the C-BF mode according to the target channel state information.

In some embodiments, where determining, by the second AP, the target channel state information among the pre-stored channel state information according to the first information, includes:
eliminating, by the second AP, the following channel state information among the pre-stored channel state information according to the first information, to obtain the target channel state information:
channel state information between the second AP and a second-type STA associated with the second AP; and
channel state information between the second AP and an STA associated with a second-type AP;
where the second-type STA is an STA that does not participate in the multi-AP coordinated transmission in C-BF, and the second-type AP is an AP that does not participate in the multi-AP coordinated transmission in C-BF.

In some embodiments, the method further includes:
transmitting, by the second AP by using the steering matrix, data to an STA associated with the second AP and participating in the multi-AP coordinated transmission in C-BF.

In some embodiments, the pre-stored channel state information is obtained by the second AP during a channel sounding phase.

In some embodiments, the second AP is an AP in the multi-AP coordinated set and participating in the multi-AP coordinated transmission in the C-BF mode.

In some embodiments, the first AP is a sharing AP, and the second AP is a shared AP.

In some embodiments, the first AP is a master AP and the second AP is a slave AP.

FIG. 6 is a schematic interaction diagram of a method 200 of wireless communication, according to the embodiments of the present disclosure. As shown in FIG. 6, the method 200 includes the following content:
S210: transmitting, by a first access point (AP), first information to at least one second AP.

In some embodiments, the first AP and the at least one second AP belong to the multi-AP coordinated set.

In some embodiments, the first AP is a sharing AP, and the second AP is a shared AP.

In some embodiments, the first AP is an MAP and the second AP is an SAP.

In some embodiments, the first AP is both a sharing AP and an MAP.

In some embodiments, an AP in the multi-AP coordinated set pre-stores channel state information, and the channel state information may be obtained in a channel sounding phase, for example, obtained in a most recent channel sounding phase. The channel state information may be used to calculate a steering matrix for C-BF.

In some embodiments, the steering matrix for C-BF is also referred to as a C-BF steering matrix, or transmission matrix (TX Matrix).

In some embodiments, the channel state information may include channel state information between an AP and an associated STA and channel state information between the AP and a non-associated STA (e.g., OBSS STA), where the associated STA refers to an STA associated with the AP, and the OBSS STA refers to an STA in an OBSS of the AP.

Optionally, the multi-AP coordinated transmission mode of C-BF of the embodiments of the present disclosure is applicable for relatively static scenarios where positions of APs and/or STAs are relatively fixed and wireless channel changes in the environment are relatively weak. When the wireless communication environment changes significantly (for example, the APs and/or STAs undergo significant position changes, or other APs and/or STAs are newly added), the pre-stored channel state information cannot accurately reflect the CSI information between each AP and each STA. Coordinated transmission based on a steering matrix calculated based on the channel state information before the wireless communication environment changes may result in poor performance of C-BF. In this case, it is necessary to re-perform the previous channel sounding or perform partial channel sounding to obtain the latest and more accurate channel state information, and then re-calculate a new steering matrix according to the latest channel state information, to enable the performance of C-BF to be maintained at the best state.

In some embodiments, the first information is used to indicate participation of APs of a multi-AP coordinated set in a multi-AP coordinated transmission in a C-BF mode and/or participation of STAs associated with APs of the multi-AP coordinated set in the multi-AP coordinated transmission in the C-BF mode.

In some embodiments, the participation of the AP in the multi-AP coordinated transmission in the C-BF mode may include whether the AP participates in the multi-AP coordinated transmission in the C-BF mode, and the participation of the STA in the multi-AP coordinated transmission in the C-BF mode may include whether the STA participates in the multi-AP coordinated transmission in the C-BF mode.

In the embodiments of the present disclosure, participating in the multi-AP coordinated transmission in the C-BF mode is also referred to as participating in C-BF, and the multi-AP coordinated transmission is also referred to as a coordinated transmission. For example, an AP participating in the multi-AP coordinated transmission in the C-BF mode may also be expressed as an AP participating in C-BF, and an STA participating in the multi-AP coordinated transmission in the C-BF mode may be expressed as an STA participating in C-BF.

For the convenience of distinction and explanation, an AP participating in C-BF in the multi-AP coordinated set is recorded as a first-type AP, an AP not participating in C-BF in the multi-AP coordinated set is recorded as a second-type AP, an STA participating in C-BF is recorded as a first-type STA, and an STA not participating in C-BF is recorded as a second-type STA.

In some embodiments, the at least one second AP is the first-type AP.

That is, the first AP informs the first information only to the AP participating in C-BF.

In some embodiments, the first information may indicate at least one of the following:
the first-type AP, the second-type AP, the first-type STA, or the second-type STA.

Therefore, the second AP may determine an AP participating in C-BF and/or an STA participating in C-BF according to the first information.

In some embodiments, for the second-type AP, its associated STAs usually do not participate in C-BF. Therefore, the first-type STA may be the first-type STA corresponding to the first-type AP, and the second-type STA may be the second-type STA corresponding to the first-type AP.

That is, the first information may indicate at least one of the following:
the first-type AP, the second-type AP, the first-type STA associated with the first-type AP, or the second-type STA associated with the first-type AP.

As an example but not limitation, the first information is used to indicate at least one of the following:
the at least one AP, including APs in the multi-AP coordinated set and participating in the multi-AP coordinated transmission in the C-BF mode, and/or APs in the multi-AP coordinated set and not participating in the multi-AP coordinated transmission in the C-BF mode; or
at least one STA set, where each STA set corresponds to an AP participating in the multi-AP coordinated transmission in the C-BF mode, and the STA set includes STAs that participate in the multi-AP coordinated transmission in the C-BF mode among STAs associated with a corresponding AP, and/or STAs that do not participate in the multi-AP coordinated transmission in the C-BF mode among STAs associated with a corresponding AP.

That is, the at least one AP includes at least one first-type AP and/or at least one second-type AP.

That is, each STA set in the at least one STA set corresponds to a first-type AP, and each STA set includes first-type STAs associated with the first-type AP and/or second-type STAs associated with the first-type AP.

In the embodiments of the present disclosure, the second AP participating in C-BF, after obtaining the first information, may calculate a steering matrix used for the second AP to perform C-BF, according to the first information and the channel state information pre-stored by the second AP. For example, the second AP may eliminate the channel state information between the second AP and the second-type STA among the pre-stored channel state information according to the first information, and calculate the steering matrix only according to the channel state information between the second AP and the first-type STA, and further perform the multi-AP coordinated transmission based on the steering matrix, which is conducive to ensuring that the second AP transmits useful signals to the target STA and transmits nulls (Nulls) to the OBSS STA, thereby achieving effective interference suppression and improving SINR of the communication link.

In some embodiments, the AP in the multi-AP coordinated set may be aware of APs included in the multi-AP coordinated set, and STAs associated with other APs in the multi-AP coordinated set. For example, in the multi-AP coordinated set establishment phase, each AP may be aware of STAs associated with other APs by information interaction.

Specific implementations of the first information are described below in conjunction with specific embodiments.

### Case 1: The First Information Only Indicates at Least One First-Type AP.

Optionally, in this case, the second AP may consider that all STAs associated with the at least one first-type AP participate in C-BF, that is, all STAs associated with the at least one first-type AP are first-type STAs, all other APs in the multi-AP coordinated set except the at least one first-type AP are the second-type APs, and all STAs associated with the second-type APs are second-type STAs.

Optionally, in a case where APs in the multi-AP coordinated set can be aware of STAs associated with other APs, and all STAs associated with APs participating in C-BF participate in C-BF, the first information may only indicate the APs participating in C-BF without indicating participation of their associated STAs.

### Case 2: The First Information Only Indicates at Least One Second-Type AP.

Optionally, in this case, the second AP may consider that all STAs associated with the at least one second-type AP do not participate in C-BF, that is, all STAs associated with the at least one second-type AP are second-type STAs, all other APs in the multi-AP coordinated set except the at least one second-type AP are first-type APs, and all STAs associated with the first-type AP are first-type STAs.

Optionally, in a case where the APs in the multi-AP coordinated set can be aware of STAs associated with other APs, and all STAs associated with the APs participating in C-BF participate in C-BF, the first information may only indicate the APs not participating in C-BF.

### Case 3: The First Information Only Indicates at Least One First-Type AP and at Least One First-Type STA Set.

Optionally, in the case 3, the number of first-type APs and the number of first-type STA sets may be the same, each first-type AP corresponds to a first-type STA set, and each first-type STA set is used to indicate STAs participating in C-BF and associated with the corresponding first-type AP, and then, other STAs associated with the first-type AP are all second-type STAs.

Optionally, in the case 3, the number of first-type APs and the number of first-type STA sets may be different, for example, the number of first-type APs is greater than the number of first-type STA sets.

Optionally, in this case, for a first-type AP that does not correspond to a first-type STA set, it may be considered that all STAs associated with the first-type AP participate in C-BF, and for a first-type AP that corresponds to a first-type STA set, STAs participating in C-BF among STAs associated with the first-type AP may be determined according to the first-type STA set corresponding to the first-type AP, and then, other STAs associated with the first-type AP are all second-type STAs.

### Case 4: The First Information Only Indicates at Least One First-Type AP and at Least One Second-Type STA Set.

Optionally, in the case 4, the number of first-type APs and the number of second-type STA sets may be the same, each first-type AP corresponds to a second-type STA set, each second-type STA set is used to indicate STAs that are associated with the corresponding first-type AP and do not participate in C-BF, and then, other STAs associated with the first-type AP are all first-type STAs.

Optionally, in the case 4, the number of first-type APs and the number of second-type STA sets may be different, for example, the number of first-type APs is greater than the number of second-type STA sets.

Optionally, in this case, for a first-type AP that does not correspond to a second-type STA set, it may be considered that all STAs associated with the first-type AP participate in C-BF, and for a first-type AP corresponding to a second-type STA set, STAs that do not participate in C-BF among STAs associated with the first-type AP may be determined according to the second-type STA set corresponding to the first-type AP, and then, other STAs associated with the first-type AP are all first-type STAs.

In some embodiments, the first information may directly indicate at least one first-type AP and/or at least one second-type AP.

For example, the first information includes identities (IDs) of at least one first-type AP, or IDs of at least one second-type AP.

That is, the first AP may explicitly indicate the IDs of the APs participating in C-BF, or the IDs of the APs not participating in C-BF.

In some other embodiments, the first information may indicate at least one first-type AP and/or at least one second-type AP by a bitmap.

For example, the first information includes a first C-BF bitmap, the first C-BF bitmap includes N bits, each bit corresponds to an AP in the multi-AP coordinated set. For example, a first bit corresponds to a first AP in the multi-AP coordinated set, a second bit corresponds to a second AP in the multi-AP coordinated set, and so on. The value of each bit is used to indicate whether the corresponding AP participates in C-BF, where N is the number of APs included in the multi-AP coordinated set, and N is a positive integer greater than 1.

Optionally, if an AP in the multi-AP coordinated set can be aware of which APs the multi-AP cooperation set includes, the first information may not include IDs of APs in the multi-AP coordinated set, and only needs to include the first C-BF bitmap, as long as the APs in the multi-AP coordinated set have a consistent understanding of the correspondence between each bit in the first C-BF bitmap and the AP.

In some embodiments, the first information may directly indicate at least one first-type STA set and/or at least one second-type STA set.

For example, the first information includes at least one STA list participating in C-BF (i.e., the first-type STA set) and/or at least one STA list not participating in C-BF (i.e., the second-type STA set), where each STA list participating in C-BF corresponds to a first-type AP, and each STA list not participating in C-BF corresponds to a first-type AP, the STA list participating in C-BF is used to indicate first-type STAs associated with the corresponding first-type AP, and the STA list not participating in C-BF is used to indicate second-type STAs associated with the corresponding first-type AP.

For example, the first AP may indicate the IDs of the STAs participating in C-BF or the IDs of the STAs not participating in C-BF, associated with the first-type AP.

In some other embodiments, the first information may indicate at least one first-type STA set and/or at least one second-type STA set by a bitmap.

For example, the first information includes at least one associated STA list and at least one second C-BF bitmap, where each STA list corresponds to a first-type AP, and each second C-BF bitmap corresponds to a first-type AP. The associated STA list is used to indicate all STAs associated with the corresponding first-type AP. The second C-BF bitmap includes K bits, and each bit corresponds to an STA in the associated STA list of the first-type AP. For example, a first bit corresponds to a first STA in the associated STA list of the first-type AP, a second bit corresponds to a second STA in the associated STA list of the first-type AP, and so on. The value of each bit is used to indicate whether the corresponding STA participates in C-BF, where K is the number of STAs associated with the first-type AP, and K is a positive integer.

Optionally, if an AP in the multi-AP coordinated set can be aware of STA information associated with other APs in the multi-AP coordinated set, the first information may not include the at least one associated STA list, only needs to include at least one second C-BF bitmap, as long as the APs in the multi-AP coordinated set have a consistent understanding of the correspondence between each bit in the second C-BF bitmap and the STA.

In some embodiments, the first information further includes first indication information, where the first indication information is used to indicate an adopted coordinated transmission mode. For example, the first indication information is used to indicate the multi-AP coordinated transmission adopting the C-BF mode.

In some embodiments, the first information is carried in a first frame, the first frame includes a coordinated transmission (TX) announce field, and the coordinated transmission announce field is used to carry the first information.

In some embodiments, the first frame is also referred to as a coordinated TX announce frame, or other similar names, which is not limited to the present disclosure.

It should be understood that in the embodiments of the present disclosure, the naming of frames or fields is only an example and should not constitute any limitation to the present disclosure. The specific protection scope shall be based on the information carried in the frames or fields.

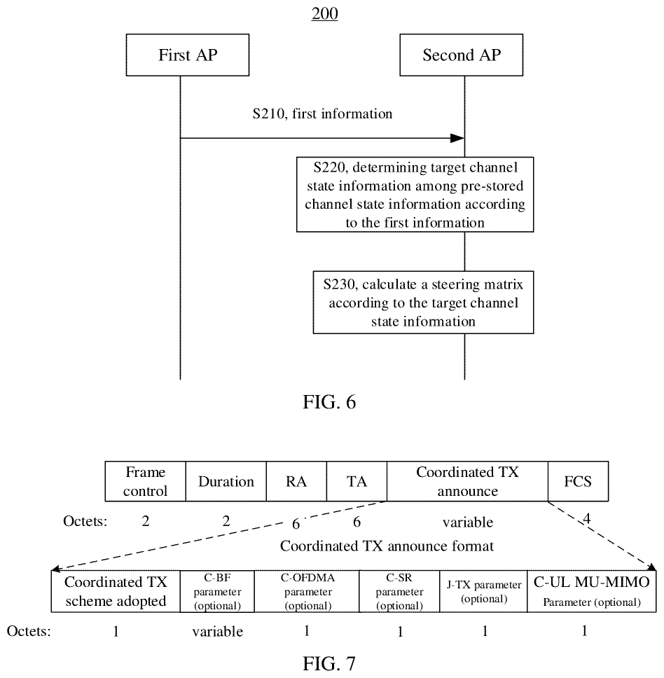

FIG. 7 is a schematic diagram of a frame format of a coordinated TX announce frame, provided in the embodiments of the present disclosure. It should be understood that information carried in the frame format, and a position and size of each field in the frame format shown in FIG. 7 are merely examples, which may be flexibly adjusted according to actual needs or the carried information. Moreover, when the first information is indicated by other methods in the aforementioned embodiments, the frame format of the coordinated TX announce frame may be adaptively adjusted, which is not limited to the present disclosure.

As shown in FIG. 7, the coordinated TX announce frame may include the following domains (or fields):
frame control (occupying 2 bytes), duration (occupying 2 bytes), receiving address (RA, occupying 6 bytes), transmission address (TA, occupying 6 bytes), coordinated TX announce (variable number of occupied bytes), frame check sequence (FCS, occupying 4 bytes).

In some embodiments, as shown in FIG. 7, the coordinated transmission announce field includes at least one of the following fields:

a coordinated TX scheme adopted field, to indicate a mode adopted to perform the multi-AP coordinated transmission, that is, to carry the aforementioned first indication information;
a C-BF parameters field (C-BF Parameters field), to indicate parameters or commands adopted to perform the multi-AP coordinated transmission in the C-BF mode, that is, to carry the aforementioned first information;
a coordinated orthogonal frequency division multiple access (C-OFDMA) parameters field (C-OFDMA Parameters field), to indicate parameters or commands adopted to perform the multi-AP coordinated transmission in a C-OFDMA mode;
a coordinated spatial reuse (C-SR) parameters field (C-SR Parameters field), to indicate parameters or commands adopted to perform the multi-AP coordinated transmission in a C-SR mode;
a joint transmission (J-TX) parameters field (J-TX Parameters field), to indicate parameters or commands adopted to perform the multi-AP coordinated transmission in a J-TX mode; or
a coordinated uplink multiple user multiple input multiple output (C-UL MU MIMO) parameters field (C-UL MU-MIMO Parameters field), to indicate parameters or commands adopted to perform the multi-AP coordinated transmission in a C-UL MU MIMO mode.

In some embodiments, the coordinated TX scheme adopted field may occupy 1 byte.

In some embodiments, the C-BF Parameters field may occupy a variable number of bytes.

In some embodiments, the C-OFDMA Parameters field may occupy 1 byte.

In some embodiments, the C-SR Parameters field may occupy 1 byte.

In some embodiments, the J-TX Parameters field may occupy 1 byte.

In some embodiments, the C-UL MU-MIMO Parameters field may occupy 1 byte.

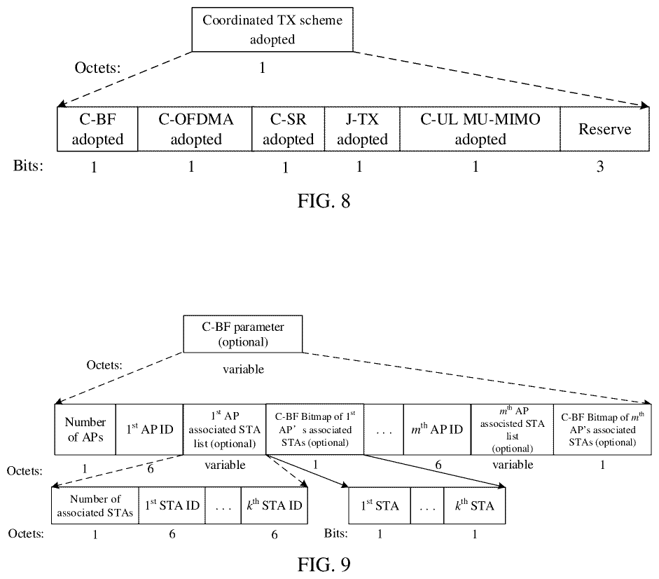

In some embodiments, as shown in FIG. 8, the coordinated TX scheme adopted field includes at least one of the following fields:
a C-BF adopted field, to indicate whether the multi-AP coordinated transmission in the C-BF mode is adopted;
a C-OFDMA adopted field, to indicate whether the multi-AP coordinated transmission in the C-OFDMA mode is adopted;
a C-SR adopted field, to indicate whether the multi-AP coordinated transmission in the C-SR mode is adopted;
a J-TX adopted field, to indicate whether the multi-AP coordinated transmission in the J-TX mode is adopted; or
a C-UL MU MIMO adopted field, to indicate whether the multi-AP coordinated transmission in the C-UL MU MIMO mode is adopted.

Optionally, the value of the C-BF adopted field being 1, indicates to perform the multi-AP coordinated transmission in the C-BF mode, in this case, the first frame includes the C-BF Parameters field. The value of the C-BF adopted field being 0, indicates not to perform the multi-AP coordinated transmission in the C-BF mode, in this case, the first frame does not include the C-BF Parameters field.

Optionally, the value of the C-OFDMA adopted field being 1, indicates to perform the multi-AP coordinated transmission in the C-OFDMA mode, in this case, the first frame includes the C-OFDMA Parameters field. The value of the C-OFDMA adopted field being 0, indicates not to perform the multi-AP coordinated transmission in the C-OFDMA mode, in this case, the first frame does not include the C-OFDMA Parameters field.

Optionally, the value of the C-SR adopted field being 1, indicates to perform the multi-AP coordinated transmission in the C-SR mode, in this case, the first frame includes the C-SR Parameters field. The value of the C-SR adopted field being 0, indicates not to perform the multi-AP coordinated transmission in the C-SR mode, in this case, the first frame does not include the C-SR Parameters field.

Optionally, the value of the J-TX adopted field being 1, indicates to perform the multi-AP coordinated transmission in the J-TX mode, in this case, the first frame includes the J-TX Parameters field. The value of the J-TX adopted field being 0, indicates not to perform the multi-AP coordinated transmission in the J-TX mode, in this case, the first frame does not include the J-TX Parameters field.

Optionally, the value of the C-UL MU-MIMO adopted field being 1, indicates to perform the multi-AP coordinated transmission in the C-UL MU-MIMO mode, in this case, the first frame includes the C-UL MU-MIMO Parameters field. The value of the C-UL MU-MIMO adopted field being 0, indicates not to perform the multi-AP coordinated transmission in the C-UL MU-MIMO mode, in this case, the first frame does not include the C-UL MU-MIMO Parameters field.

In some embodiments, the C-BF Parameters field includes at least one of the following fields:
a number of APs field, to indicate the number of APs included in the first frame;
at least one AP ID field, to indicate an AP participating in the multi-AP coordinated transmission in the C-BF mode and/or an AP not participating in the multi-AP coordinated transmission in the C-BF mode;
at least one associated STA list field, where each associated STA list field corresponds to an AP indicated by the at least one AP ID field, and the associated STA list field is used to indicate a list of STAs associated with a corresponding AP; or
at least one C-BF bitmap (the aforementioned second C-BF bitmap) field, where each C-BF bitmap field corresponds to an AP indicated by the at least one AP ID field, and the C-BF bitmap field is used to indicate whether STAs in a list of STAs associated with a corresponding AP participate in the multi-AP coordinated transmission in the C-BF mode. That is, at least one C-BF bitmap field is used to carry the second C-BF bitmap.

In some embodiments, as shown in FIG. 9, the at least one AP ID field may include a first AP ID (i.e., 1^{st} AP ID) field, . . . , an m-th AP ID (i.e., m^{th} AP ID) field, etc., the first AP ID (1^{st} AP ID) field indicates an ID of an AP first participating in C-BF, and the m^{th} AP ID indicates an ID of an AP m-th participating in C-BF.

Optionally, the at least one AP ID field is used to indicate the AP participating in C-BF.

In some embodiments, as shown in FIG. 9, the at least one associated STA list field may include an associated STA list of a first AP (i.e., the AP indicated by the first AP ID field) field (Associated STA List of 1^{st} AP field), . . . , an associated STA list of m-th AP (i.e., the AP indicated by the m-th AP ID field) field (Associated STA List of m^{th} AP ID field), etc. The Associated STA List of 1^{st} AP field indicates a list of STAs associated with an AP first participating in C-BF, and the Associated STA List of m^{th} AP ID indicates a list of STAs associated with an AP m-th participating in C-BF.

Further, as shown in FIG. 9, each associated STA list field includes at least one of the following fields:
a number of associated STAs field (Number of Associated STAs field), used to indicate the number of STAs associated with a current AP; or
at least one STA ID field, used to indicate STAs associated with the current AP, a k^{th} STA ID is used to indicate an ID of the k^{th} STA associated with the current AP.

In some embodiments, as shown in FIG. 9, the at least one C-BF bitmap field may include a C-BF bitmap of a first AP's (i.e., the AP indicated by the first AP ID field) associated STAs field (C-BF Bitmap of 1^{st} AP's Associated STAs field), . . . , a C-BF bitmap of m-th AP's (i.e., the AP indicated by the m-th AP ID field) associated STAs field (C-BF Bitmap of m^{th} AP's Associated STAs field), etc. The C-BF Bitmap of 1^{st} AP's Associated STAs field is used to indicate whether STAs in a list of STAs associated with an AP first participating in C-BF participate in C-BF, and the C-BF Bitmap of m^{th} AP's Associated STAs field indicates whether STAs in a list of STAs associated with an AP m-th participating in C-BF participate in C-BF.

In some embodiments, as shown in FIG. 9, the C-BF bitmap field may include k STA bits, k represents the number of STAs associated with the AP, and each STA bit corresponds to a STA associated with the AP. For example, the 1^{st} STA bit corresponds to the 1^{st} STA associated with the AP, and the k^{th} STA bit corresponds to the k^{th} STA associated with the AP. The STA bit corresponding to each STA is used to indicate whether the STA participates in C-BF. As an example, if a certain STA participates in C-BF, the STA bit corresponding to the STA is set to 1, otherwise, it is set to 0.

It should be understood that FIG. 9 only takes an example of indicating the participation of an STA in C-BF by a bitmap. In other embodiments, the STA participating in C-BF or the STA not participating in C-BF may also be directly indicated.

For example, the C-BF Parameters field may also include at least one of the following fields:
a number of APs field, to indicate the number of APs included in the first frame;
at least one AP ID field, to indicate at least one AP participating in the multi-AP coordinated transmission in the C-BF mode; or
at least one STA list participating in C-BF field, where each STA list participating in C-BF field corresponds to an AP indicated by the at least one AP ID field, and the STA list participating in C-BF field is used to indicate STAs associated with a corresponding AP and participating in the multi-AP coordinated transmission in the C-BF mode.

For another example, the C-BF Parameters field includes at least one of the following fields:
a number of APs field, to indicate the number of APs included in the first frame;
at least one AP ID field, to indicate at least one AP participating in the multi-AP coordinated transmission in the C-BF mode; or
at least one STA list not participating in C-BF field, where each STA list not participating in C-BF field corresponds to an AP indicated by the at least one AP ID field, and the STA list not participating in C-BF field is used to indicate STAs associated with a corresponding AP and not participating in the multi-AP coordinated transmission in the C-BF mode.

In some embodiments of the present disclosure, the method 200 further includes:
transmitting, by the first AP, first request information to at least one third AP, where the first request information is used to request the at least one third AP to participate in the multi-AP coordinated transmission in the C-BF mode, and the at least one third AP belongs to the multi-AP coordinated set.

In some embodiments, the at least one third AP includes all APs of the multi-AP coordinated set.

In some embodiments, the at least one third AP includes the at least one second AP.

For example, the at least one second AP may be an AP participating in C-BF among the at least one third AP.

That is, the first AP may request at least one third AP to participate in C-BF, and further, transmit the first information only to the AP that agrees to participate in C-BF.

In some embodiments, the first request information includes second indication information, and the second indication information is used to indicate a coordinated transmission mode in which the first AP requests to participate. For example, the second indication information is used to indicate requesting to participate in the multi-AP coordinated transmission in the C-BF mode.

In some embodiments, in a case where the second indication information indicates requesting to participate in the multi-AP coordinated transmission in the C-BF mode, it may be considered that the first AP requests the at least one third AP to report participation of the AP and its associated STAs in C-BF.

In some embodiments, where transmitting, by the first AP, the first request information to the at least one third AP, includes:
transmitting, by the first AP, the first request information to the at least one third AP by broadcasting or multicasting; or
transmitting, by the first AP, the first request information to the at least one third AP by unicasting.

In some embodiments, the first request information is carried in a second frame.

That is, the second frame may be transmitted by broadcasting, multicasting or unicasting.

In some embodiments, the second frame is also referred to as a coordinated TX request frame, or other similar names, which is not limited to the present disclosure.

In some embodiments of the present disclosure, the method 200 further includes:
receiving, by the first AP, first response information transmitted by the at least one third AP.

The first response information is used to indicate whether the third AP participates in the multi-AP coordinated transmission in the C-BF mode and/or whether an STA associated with the third AP participates in the multi-AP coordinated transmission in the C-BF mode.

In some embodiments, the first response information is carried in a third frame.

In some embodiments, the third frame is also referred to as a coordinated TX response frame, or other similar names, which is not limited to the present disclosure.

In some embodiments, where receiving, by the first AP, the first response information transmitted by the at least one third AP, includes:
receiving, by the first AP, the first response information transmitted synchronously by the at least one third AP; or
receiving, by the first AP, the first response information transmitted asynchronously by the at least one third AP.

That is, the third frame may be transmitted synchronously or asynchronously.

For example, when the second frame is transmitted by broadcasting or multicasting, the first AP receives the third frame synchronously transmitted by the at least one third AP.

For another example, when the second frame is transmitted by unicasting, the first AP receives the third frame asynchronously transmitted by the at least one third AP.

In some embodiments, for a third AP that refuses to participate in C-BF, participation of its associated STAs in C-BF may not be indicated in first response information. In this case, it may be considered that all STAs associated with the third AP do not participate in C-BF.

In some embodiments, for a third AP participating in C-BF, participation of its associated STAs in C-BF may be indicated to the first AP in the first response information. Optionally, if all STAs associated with the third AP participate in C-BF, and other APs can be aware of the STAs associated with the third AP, the third AP may not indicate the participation of its associated STAs in C-BF in the first response information. The first AP that receives the first response information determines, according to the first response information, that all STAs associated with the third AP participate in C-BF.

In some embodiments, the first response information may directly indicate a first-type STA set and/or a second-type STA set corresponding to the third AP.

For example, the first response information includes a STA list participating in C-BF (i.e., the first-type STA set) and/or a STA list not participating in C-BF (i.e., the second-type STA set), where the STA list participating in C-BF is used to indicate the first-type STAs associated with the third AP, and the STA list not participating in C-BF is used to indicate the second-type STAs associated with the third AP.

For example, the third AP may explicitly indicate an ID of the STA participating in C-BF or an ID of the STA not participating in C-BF, associated with the third AP.

In some other embodiments, the first response information may indicate the first-type STA set and/or the second-type STA set corresponding to the third AP by a bitmap.

For example, the first response information includes an associated STA list and a third C-BF bitmap, the associated STA list is used to indicate all STAs associated with the third AP, the third C-BF bitmap includes K bits, each bit corresponds to an STA in the associated STA list of the third AP. For example, a first bit corresponds to a first STA in the associated STA list of the third AP, a second bit corresponds to a second STA in the associated STA list of the third AP, and so on. The value of each bit is used to indicate whether the corresponding STA participates in C-BF, where K is the number of STAs associated with the third AP, and K is a positive integer.

Optionally, if the first AP can be aware of STA information associated with the AP in the multi-AP coordinated set, the first response information may not include the associated STA list, but only needs to include the third C-BF bitmap, as long as the first AP and the third AP have a consistent understanding of the correspondence between each bit in the third C-BF bitmap and the STA.

In some embodiments, the first response information further includes third indication information, and the third indication information is used to indicate a coordinated transmission mode accepted by the third AP. For example, the third indication information is used to indicate whether to accept the multi-AP coordinated transmission in C-BF.

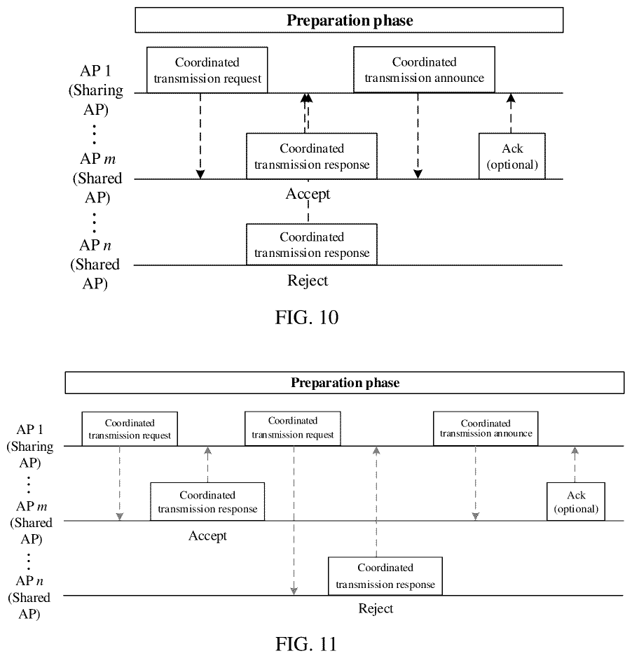

In conjunction with FIG. 10 and FIG. 11, taking the first AP being AP1, whose role is a sharing AP, and the at least one third AP including AP m, AP n, etc., whose roles are shared APs, as an example, a interaction manner of the coordinated transmission request frame and the coordinated transmission response frame is described.

As shown in FIG. 10, the sharing AP may transmit the coordinated transmission request frame to the shared APs by broadcasting or multicasting, to request the shared APs to participate in the multi-AP coordinated transmission in the C-BF mode, or to inquire the shared APs whether to participate in the multi-AP coordinated transmission in the C-BF mode, and the shared APs may synchronously reply with the coordinated transmission response frame.

For example, AP m, when participating in C-BF, replies with the coordinated transmission response frame, to indicate that the request of the sharing AP is accepted.

In this case, the AP m may also indicate a first-type STA set and/or a second-type STA set associated with the AP m in the coordinated transmission response frame.

For another example, AP n, without participating in C-BF, replies with the coordinated transmission response frame, to indicate that the request of the sharing AP is rejected.

In this case, the AP n may not indicate the first-type STA set and/or the second-type STA set associated with the AP n in the coordinated transmission response frame, because all STAs associated with the AP n do not participate in C-BF.

Furthermore, the sharing AP may transmit a coordinated transmission announce frame, to inform the collected information on whether the shared APs participate in C-BF and/or information on whether STAs associated with the shared APs participate in C-BF, to the shared AP participating in C-BF.

Optionally, the shared AP that receives the coordinated transmission announce frame may confirm the coordinated transmission announce frame transmitted by the sharing AP, via an acknowledgement (Ack) frame, or the shared AP may not transmit the Ack frame and accept the coordinated transmission announce frame transmitted by the sharing AP by default.

As shown in FIG. 11, the sharing AP transmits the coordinated transmission request frame to the shared APs by unicasting, to request the shared APs to participate in the multi-AP coordinated transmission in the C-BF mode, or to inquire the shared APs whether to participate in the multi-AP coordinated transmission in the C-BF mode. The shared APs may asynchronously reply with the coordinated transmission response frame.

For example, after the sharing AP transmits the coordinated transmission request frame to an AP m, AP m, in the case of participating in C-BF, replies with the coordinated transmission response frame, to indicate that the request of the sharing AP is accepted. In this case, the AP m may also indicate a first-type STA set and/or a second-type STA set associated with the AP m in the coordinated transmission response frame.

For another example, after the sharing AP transmits the coordinated transmission request frame to an AP n, the AP n without participating in C-BF, replies with the coordinated transmission response frame, to indicate that the request of the sharing AP is rejected. In this case, the AP n may not indicate the first-type STA set and/or the second-type STA set associated with the AP n in the coordinated transmission response frame, because all STAs associated with the AP n do not participate in C-BF.

Furthermore, the sharing AP may transmit a coordinated transmission announce frame, to inform the collected information on whether the shared APs participate in C-BF and/or information on whether STAs associated with the shared APs participate in C-BF, to the shared AP participating in C-BF.

Optionally, the shared AP that receives the coordinated transmission announce frame may confirm the coordinated transmission announce frame transmitted by the sharing AP, via an Ack frame, or the shared AP may not transmit the Ack frame and accept the coordinated transmission announce frame transmitted by the sharing AP by default.

The design of frame formats of the coordinated transmission request frame and the coordinated transmission response frame is described below, in conjunction with FIG. 12 to FIG. 15.

It should be understood that information carried in frame formats shown in FIG. 12 to FIG. 15, and a position and size of each field in the frame formats are merely examples, and may be flexibly adjusted according to actual needs or the carried information. For example, when the first response information is indicated by other methods in the aforementioned embodiments, the frame format of the coordinated transmission response frame may be adaptively adjusted, which is not limited to the present disclosure.

FIG. 12 is a schematic diagram of a frame format of the coordinated transmission request frame, provided in the embodiments of the present disclosure, which may include the following domains (or fields):
frame control (occupying 2 bytes), duration (occupying 2 bytes), receiving address (RA) (occupying 6 bytes), transmission address (TA) (occupying 6 bytes), coordinated TX request (occupying a variable number of bytes), FCS (occupying 4 bytes).

In some embodiments, as shown in FIG. 12, the coordinated transmission request field includes at least one of the following fields:
a coordinated TX scheme used field, to indicate a coordinated transmission mode requested to be used, that is, to carry the aforementioned second indication information;
a C-BF command field, to indicate a command used when the multi-AP coordinated transmission in the C-BF mode is adopted;
a C-OFDMA command field, to indicate a command used when the multi-AP coordinated transmission in a C-OFDMA mode is adopted;
a C-SR command field, to indicate a command used when the multi-AP coordinated transmission in a C-SR mode is adopted;
a J-TX command field, to indicate a command used when the multi-AP coordinated transmission in a J-TX mode is adopted; or
a C-UL MU MIMO command field, to indicate a command used when the multi-AP coordinated transmission in a C-UL MU MIMO mode is adopted.

In some embodiments, as shown in FIG. 12, the coordinated TX scheme used field includes at least one of the following fields:
a C-BF used field, to indicate whether to request to use the multi-AP coordinated transmission in the C-BF mode;
a C-OFDMA used field, to indicate whether to request to use the multi-AP coordinated transmission in the C-OFDMA mode;
a C-SR used field, to indicate whether to request to use the multi-AP coordinated transmission in the C-SR mode;
a J-TX used field, to indicate whether to request to use the multi-AP coordinated transmission in the J-TX mode; or
a C-UL MU MIMO used field, to indicate whether to request to use the multi-AP coordinated transmission in the C-UL MU MIMO mode.

Optionally, the value of the C-BF used field being 1, indicates that the shared AP is requested to perform the multi-AP coordinated transmission in the C-BF mode, in this case, the coordinated transmission request frame includes the C-BF command field. The value of the C-BF used field being 0, indicates that the shared AP is not requested to perform the multi-AP coordinated transmission in the C-BF mode, in this case, the coordinated transmission request frame does not include the C-BF command field.

Optionally, the value of the C-OFDMA used field being 1, indicates that the shared AP is requested to perform the multi-AP coordinated transmission in the C-OFDMA mode, in this case, the coordinated transmission request frame includes the C-OFDMA command field. The value of the C-OFDMA used field being 0, indicates that the shared AP is not requested to perform the multi-AP coordinated transmission in the C-OFDMA mode, in this case, the coordinated transmission request frame does not include the C-OFDMA command field.

Optionally, the value of the C-SR used field being 1, indicates that the shared AP is requested to perform the multi-AP coordinated transmission in the C-SR mode, in this case, the coordinated transmission request frame includes the C-SR command field. The value of the C-SR used field being 0, indicates that the shared AP is not requested to perform the multi-AP coordinated transmission in the C-SR mode, in this case, the coordinated transmission request frame does not include the C-SR command field.

Optionally, the value of the J-TX used field being 1, indicates that the shared AP is requested to perform the multi-AP coordinated transmission in the J-TX mode, in this case, the coordinated transmission request frame includes the J-TX command field. The value of the J-TX used field being 0, indicates that the shared AP is not requested to perform the multi-AP coordinated transmission in the J-TX mode, in this case, the coordinated transmission request frame does not include the J-TX command field.

Optionally, the value of the C-UL MU-MIMO used field being 1, indicates that the shared AP is requested to perform the multi-AP coordinated transmission in the C-UL MU-MIMO mode, in this case, the coordinated transmission request frame includes the C-UL MU-MIMO command field. The value of the C-UL MU-MIMO used field being 0, indicates that the shared AP is not requested to perform the multi-AP coordinated transmission in the C-UL MU-MIMO mode, in this case, the coordinated transmission request frame does not include the C-UL MU-MIMO command field.

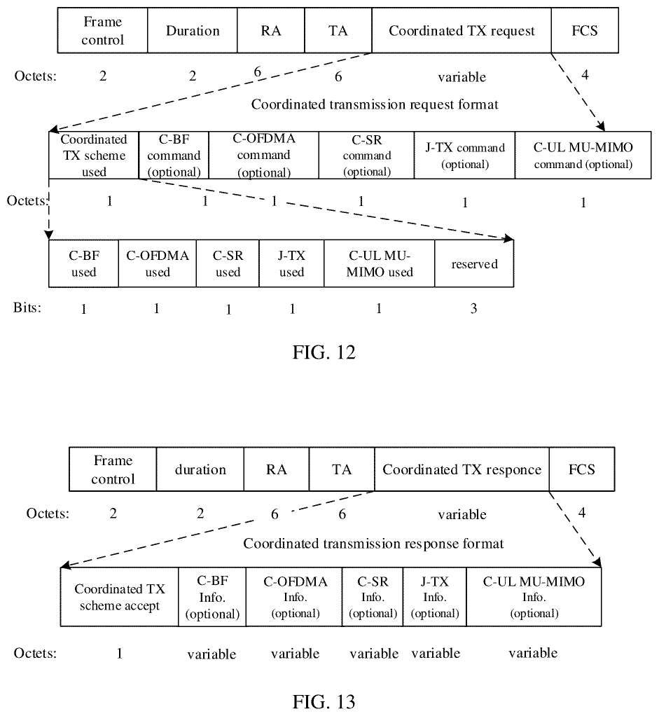

FIG. 13 to FIG. 15 are schematic diagrams of frame formats of the coordinated transmission response frame, provided in the embodiments of the present disclosure.

As shown in FIG. 13, the coordinated transmission response frame may include the following domains (or fields):
frame control (occupying 2 bytes), duration (occupying 2 bytes), receiving address (RA) (occupying 6 bytes), transmission address (TA) (occupying 6 bytes), coordinated TX response (occupying a variable number of bytes), FCS (occupying 4 bytes).

In some embodiments, as shown in FIG. 13, the coordinated transmission response field includes at least one of the following fields:
an coordinated TX scheme accept field, to indicate whether the third AP accepts a requested coordinated transmission mode;
a C-BF information field (C-BF Info. Field), to indicate information related to the third AP with C-BF;
a C-OFDMA information field (C-OFDMA Info. Field), to indicate information related to the third AP with C-OFDMA;
a C-SR information field (C-SR Info. Field), to indicate information related to the third AP with C-SR;
a J-TX information field (J-TX Info. Field), to indicate information related to the third AP with J-TX; or
a C-UL MU MIMO information field (C-UL MU MIMO Info. Field), to indicate information related to the third AP with C-UL MU MIMO.

In some embodiments, as shown in FIG. 14, the coordinated TX scheme accept field includes at least one of the following fields:
a C-BF accept field, to indicate whether the multi-AP coordinated transmission in a C-BF mode is accepted;
a C-OFDMA accept field, to indicate whether the multi-AP coordinated transmission in a C-OFDMA mode is accepted;
a C-SR accept field, to indicate whether the multi-AP coordinated transmission in a C-SR mode is accepted;
a J-TX accept field, to indicate whether the multi-AP coordinated transmission in a J-TX mode is accepted; or
a C-UL MU MIMO accept field, to indicate whether the coordinated transmission in a C-UL MU MIMO mode is accepted.

Optionally, the value of the C-BF accept field being 1, indicates that the multi-AP coordinated transmission in the C-BF mode is accepted, in this case, the coordinated transmission response frame includes the C-BF Info. field. The value of the C-BF accept field being 0, indicates that the multi-AP coordinated transmission in the C-BF mode is rejected, in this case, the coordinated transmission response frame does not include the C-BF Info. field.

Optionally, the value of the C-OFDMA accept field being 1, indicates that the multi-AP coordinated transmission in the C-OFDMA mode is accepted, in this case, the coordinated transmission response frame includes the C-OFDMA Info. field. The value of the C-OFDMA accept field being 0, indicates that the multi-AP coordinated transmission in the C-OFDMA mode is rejected, in this case, the coordinated transmission response frame does not include the C-OFDMA Info. field.

Optionally, the value of the C-SR accept field being 1, indicates that the multi-AP coordinated transmission in the C-SR mode is accepted, in this case, the coordinated transmission response frame includes the C-SR Info. field. The value of the C-SR accept field being 0, indicates that the multi-AP coordinated transmission in the C-SR mode is rejected, in this case, the coordinated transmission response frame does not include the C-SR Info. field.

Optionally, the value of the J-TX accept field being 1, indicates that the multi-AP coordinated transmission in the J-TX mode is accepted, in this case, the coordinated transmission response frame includes the J-TX Info. field. The value of the J-TX accept field being 0, indicates that the multi-AP coordinated transmission in the J-TX mode is rejected, in this case, the coordinated transmission response frame does not include the J-TX Info. field.

Optionally, the value of the C-UL MU-MIMO accept field being 1, indicates that the multi-AP coordinated transmission in the C-UL MU-MIMO mode is accepted, in this case, the coordinated transmission response frame includes the C-UL MU-MIMO Info. field. The value of the C-UL MU-MIMO accept field being 0, indicates that the multi-AP coordinated transmission in the C-UL MU-MIMO mode is rejected, in this case, the coordinated transmission response frame does not include the C-UL MU-MIMO Info. field.

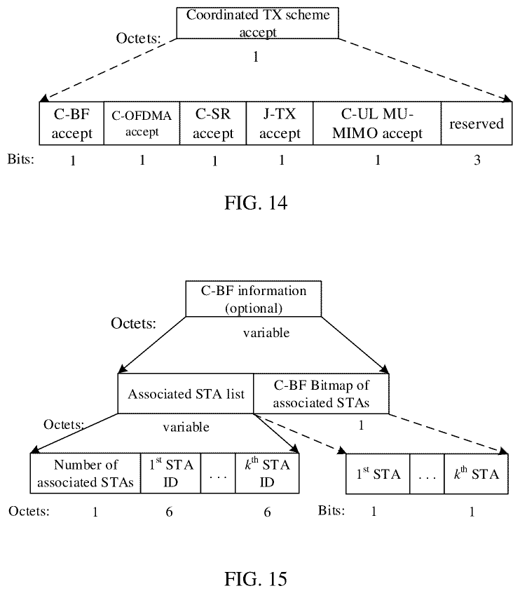

In some embodiments, as shown in FIG. 15, the C-BF information field includes at least one of the following fields:
an associated STA list field (Associated STA List subfield), to indicate a list of STAs associated with the third AP; or
a C-BF bitmap of associated STAs field (C-BF Bitmap of Associated STAs subfield), to indicate whether each STA in the list of STAs associated with the third AP participates in the multi-AP coordinated transmission in the C-BF mode. That is, the C-BF bitmap of associated STA field is used to carry the aforementioned third C-BF bitmap.

In some embodiments, as shown in FIG. 15, the associated STA list field includes at least one of the following fields:
a number of associated STAs field, to indicate the number of STAs associated with the third AP; or
at least one STA ID field, to indicate IDs of STAs associated with the third AP, where a k^{th} STA ID is used to indicate an ID of the k-th STA associated with the third AP.

In some embodiments, as shown in FIG. 15, the C-BF bitmap of associated STAs field is used to indicate whether STAs in a list of STAs associated with the third AP participate in C-BF.

For example, the C-BF bitmap of associated STAs field may include k STA bits, each STA bits corresponds to a STA associated with the third AP, for example, a 1^{st} STA bits corresponds to a 1^{st} STA associated with the third AP, a k^{th} STA bits corresponds to a k^{th} STA associated with the third AP, and the STA bits corresponding to each STA is used to indicate whether the STA participates in C-BF. As an example, if a certain STA participates in C-BF, the STA bits corresponding to the STA is set to 1, otherwise, it is set to 0.

It should be understood that FIG. 15 only takes an example of indicating the participation of STAs associated with the third AP in C-BF by the bitmap. In other embodiments, the STAs associated with the third AP and participating in C-BF or not participating in C-BF, may also be directly indicated.

For example, the C-BF information field includes an STA list participating in C-BF field, to indicate STAs associated with the third AP and participating in the multi-AP coordinated transmission in the C-BF mode.

For another example, the C-BF information field includes a STA list not participating in C-BF field, to indicate STAs associated with the third AP and not participating in the multi-AP coordinated transmission in the C-BF mode.

In some embodiments, as shown in FIG. 6, the method 200 further includes:
S220, determining, by the second AP, target channel state information among pre-stored channel state information according to the first information;
S230, calculating a steering matrix for the multi-AP coordinated transmission in the C-BF mode according to the target channel state information.

For example, the second AP eliminates the following channel state information among the pre-stored channel state information according to the first information, to obtain the target channel state information:
channel state information between the second AP and a second-type STA associated with the second AP;
channel state information between the second AP and an STA associated with a second-type AP.

Furthermore, the second AP uses the steering matrix to transmit data to the STA associated with the second AP and participating in the multi-AP coordinated transmission in C-BF, which is conducive to ensuring that the second AP transmits useful signals to the target STA and transmits nulls (Nulls) to the OBSS STA, thereby achieving effective interference suppression and improving the SINR of the communication link.

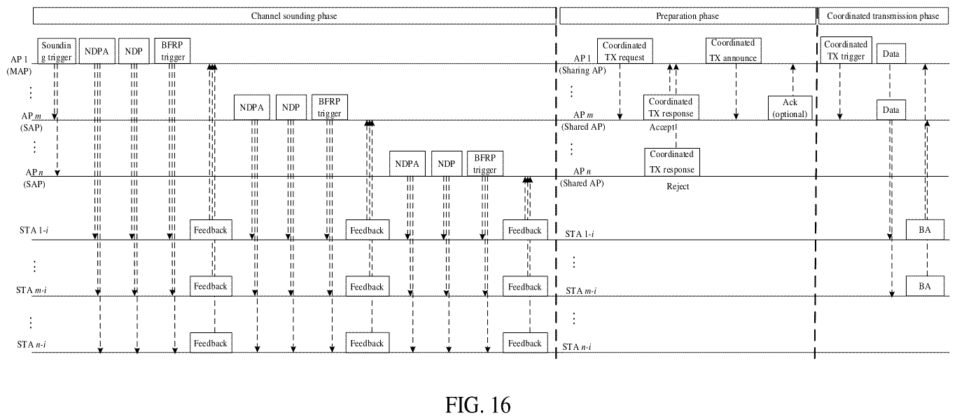

In conjunction with a specific example shown in FIG. 16, a process of the multi-AP coordinated transmission in the C-BF mode according to the embodiments of the present disclosure is described.

In the example of FIG. 16, the establishment of a multi-AP coordinated set supporting C-BF has been completed, where in the channel sounding phase, an AP1 is an MAP, an AP m and an AP n are SAPs in the multi-AP coordinated set, where an STA 1-i is associated with the AP 1, an STA m-i is associated with the AP m, and an STA n-i is associated with the AP n, where i represents an i-th STA associated with the AP.

### I. Channel Sounding Phase

In the channel sounding phase, APs (including the MAP and SAPs) in the multi-AP coordinated set perform sequential channel sounding, and each AP obtains and stores channel state information between the AP and each STA (including associated STAs and OBSS STAs). For the specific sounding method, please refer to the relevant description of the embodiments shown in FIG. 5, which will not be repeated here.

As an example but not limitation, the channel state information stored by the APs in the multi-AP coordinated set may be as shown in Table 1. After completing the channel sounding, the AP 1 may store a row of channel state information corresponding to the AP 1, the AP m may store a row of channel state information corresponding to the AP m, the AP n may store a row of channel state information corresponding to the AP n, and so on.

TABLE 1
Channel state information obtained
by each AP through channel sounding

| | STA 1 − i | . . . | STA m − i | . . . | STA n − i |
|---|---|---|---|---|---|
| AP 1 | H(1, 1 − i) | . . . | H(1, m − i) | . . . | H(1, n − i) |
| . . . | . . . | . . . | . . . | . . . | . . . |
| AP m | H(m, 1 − i) | . . . | H(m, m − i) | . . . | H(m, n − i) |
| . . . | . . . | | . . . | . . . | . . . |
| AP n | H(n, 1 − i) | . . . | H(n, m − i) | . . . | H(n, n − i) |

Herein, H(1,1-i) represents the channel state information between the AP 1 and STA 1-i, H(m,1-i) represents the channel state information between the AP m and STA 1-i, H(n,1-i) represents the channel state information between the AP n and STA 1-i, and the meanings of other channel state information are similar and are not repeated here.

### II. Preparation Phase

In the preparation phase, the sharing APs transmit a coordinated transmission request frame carrying the aforementioned first request information, for example, which may be transmitted by broadcasting or multicasting, or may also be transmitted by unicasting. The shared APs reply with a coordinated transmission response frame carrying the aforementioned first response information, for example, the shared APs reply with the coordinated transmission response frame synchronously or asynchronously.

It should be understood that FIG. 16 only takes an example in which the sharing AP transmits the coordinated transmission request frame by broadcasting or multicasting, and the shared APs synchronously transmit the coordinated transmission response frame, but the present disclosure is not limited thereto.

The sharing AP may determine the participation of the APs of the multi-AP cooperative transmission set in C-BF and/or the participation of the STAs associated with the APs of the multi-AP coordinated transmission set in C-BF, according to the coordinated transmission response frame replied by the shared APs.

That is, the sharing AP may obtain the first information according to the coordinated transmission response frame replied by the shared AP.

The sharing AP transmits a coordinated transmission announce frame to the shared AP. For example, the sharing AP transmits the coordinated transmission announce frame only to the shared AP participating in C-BF, where the coordinated transmission announce frame carries the first information.

For example, the sharing AP informs which APs and which of their associated STAs participate in C-BF and/or which APs and which of their associated STAs do not participate in C-BF, in the coordinated transmission announce frame, to the shared AP participating in C-BF.

As an example but not limitation, the first information may be used to indicate the following participation information that:
an AP 1 and its associated STA 1-i participate in C-BF, and other STAs do not participate in C-BF;
an AP m and its associated STA m-i participate in C-BF, and other STAs do not participate in C-BF;
an AP n does not participate in C-BF, which means that all STAs associated with the AP n do not participate in C-BF; and
further, the shared APs (e.g., AP 1 and AP m) participating in C-BF determine, according to the first information, the target channel state information for calculating the steering matrix among the stored channel state information.

For example, the AP 1 and AP m eliminate the following channel state information in Table 1 to obtain the target channel state information:
1) channel state information between the AP participating in C-BF and its associated STAs not participating in C-BF, for example:
   the AP 1 eliminates other channel state information except H(1,1-i) and H(1,m-i) in Table 1; and
   the AP m eliminates other channel state information except H(m, 1-i) and H (m,m-i) in Table 1.
2) channel state information between the AP participating in C-BF and all STAs associated with the AP not participating in C-BF, for example:
   the AP 1 eliminates the channel state information of STAs associated with the AP n in Table 1 (i.e., H(1,n-i)); and
   the AP m eliminates the channel state information of STAs associated with the AP n in Table 1 (i.e., H (m,n-i)).

Then, the shared AP participating in C-BF calculates the C-BF steering matrix for the shared AP to perform the multi-AP coordinated transmission, according to the target channel state information.

For example, the AP 1 and AP m calculate the steering matrix according to the target channel state information after eliminating the relevant channel state information in Table 1.

For example, the AP 1 calculates the C-BF steering matrix used by the AP 1, based on the channel state information (H(1,1-i) and H(1,m-i)), and the AP m calculates the C-BF steering matrix used by the AP m, based on the channel state information (H(m, 1-i) and H(m,m-i)).

It should be understood that the present disclosure does not limit the method for calculating the C-BF steering matrix. The principle for calculating the C-BF steering matrix is to enhance the signal quality (e.g. SINR) of STAs participating in C-BF and associated with the AP, and to weaken the signal quality of the non-associated STAs participating in C-BF (i.e., STAs participating in C-BF under other APs) (i.e., nulls of the transmitted signal is aligned to the non-associated STAs participating in C-BF), thereby achieving effective interference suppression and improving the SINR of the communication link.

It should be noted that in the embodiments of the present disclosure, when the wireless communication environment changes significantly (for example, the AP and/or STA undergo a significant position change or other APs and/or STAs are newly added), the pre-stored channel state information cannot accurately reflect the channel state information between each AP and each STA. In this case, the coordinated transmission based on a steering matrix calculated based on the channel state information obtained before the wireless communication environment changes may result in poor performance of C-BF. At this time, it is necessary to re-perform the previous channel sounding or perform partial channel sounding to obtain the latest and more accurate channel state information, and then re-calculate a new steering matrix according to the latest channel state information, to enable the performance of C-BF to be maintained at the best state.

### III. Coordinated Transmission Phase

In the coordinated transmission phase, the sharing AP transmits a coordinated TX trigger frame to trigger APs participating in C-BF to perform the multi-AP coordinated transmission. For example, the shared APs participating in C-BF transmit data according to the steering matrix calculated based on the target channel state information.

Optionally, if the sharing AP also participates in C-BF, the sharing AP also transmits data together with other shared APs participating in C-BF, based on the steering matrix calculated in advance. Each STA, after receiving the data, replies with a block acknowledgement (BA) frame.

It should be noted that FIG. 16 only takes an example in which the MAP and the sharing AP are the same AP. In other embodiments, the MAP and the sharing AP may also be different APs, which are not limited to the present disclosure.

In some embodiments, the sharing AP may also notify the first information to the APs participating in C-BF during the coordinated transmission phase. In this case, during the preparation phase, the sharing AP may not transmit the coordinated transmission announce frame. For example, the sharing AP may carry the first information in the coordinated TX trigger frame. Further, the shared APs participating in C-BF may calculate the steering matrix according to the first information by the aforementioned method. This method may be applicable to the shared APs with a strong processing capability.

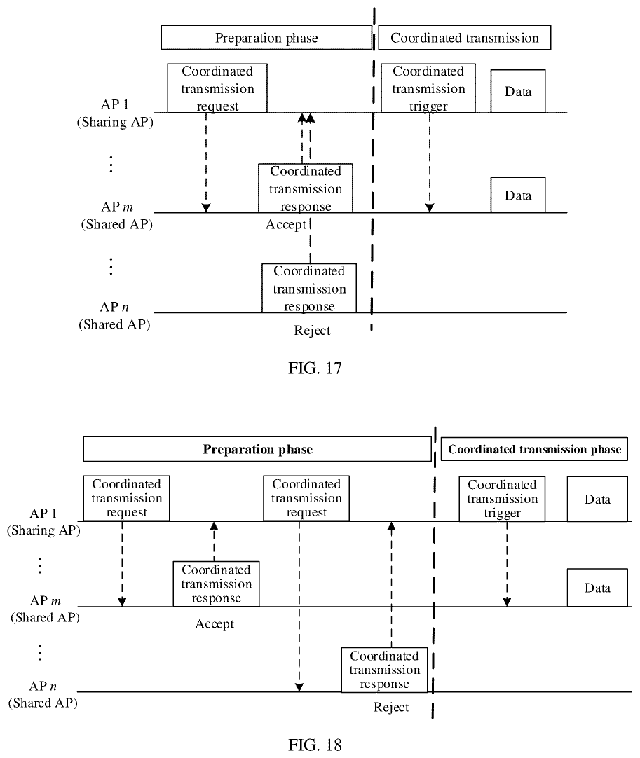

As shown in FIG. 17 and FIG. 18, for the shared APs with a strong processing capability, the steering matrix may be calculated according to the first information by the aforementioned method in a very short time (e.g., SIFS, PIFS (Point Interframe Spacing), or DIFS (Distributed Interframe Spacing), etc.). Then the sharing AP may also not transmit the coordinated transmission announce frame in the preparation phase to inform the first information to the shared APs participating in C-BF, but instead, inform the first information to each shared AP participating in C-BF by the coordinated TX trigger frame in the coordinated transmission phase, and then each shared AP participating in C-BF calculates the steering matrix according to the first information by the aforementioned method, and transmits data according to the steering matrix. That is, the steps of coordinated transmission announce and reply (optional) in FIG. 16 are omitted.

That is, in the coordinated transmission phase, the sharing AP directly uses the coordinated TX trigger frame to implement the function of the coordinated transmission announce frame. Herein, the design of the frame format of the coordinated TX trigger frame refers to the design of the frame format of the coordinated transmission announce frame shown in FIG. 7 to FIG. 9, which will not be repeated here.

Herein, the difference between FIG. 17 and FIG. 18 is that, in the preparation phase in FIG. 17, the shared APs synchronously reply to the coordinated transmission request of the sharing AP, and in the preparation phase in FIG. 18, the shared APs asynchronously reply to the coordinated transmission request of the sharing AP.

In summary, in the embodiments of the present disclosure, the sharing AP may collect the participation of the shared APs of the multi-AP coordinated set and their associated STAs in the multi-AP coordinated transmission in C-BF, and further notify the participation to the AP participating in the multi-AP coordinated transmission in C-BF, so that the AP may determine the target channel state information for calculating the steering matrix among the pre-stored channel state information according to the participation, and calculate the steering matrix based on the target channel state information. Exemplarily, the AP, when calculating the steering matrix, only considers this AP, and the STA participating in C-BF, so that it can be implemented that the AP transmits useful signals to the target STA and transmits nulls to the OBSS STA, thereby reducing the interference and improving the transmission performance.

Moreover, in the method of calculating the steering matrix by the AP participating in C-BF, provided in the embodiments of the present disclosure, the AP only needs to eliminate the pre-stored channel state information according to the first information, to obtain the target channel state information for calculating the steering matrix, and there is no need to exchange the channel state information between APs, thereby enabling the calculation of the steering matrix of C-BF with a lower signaling overhead.

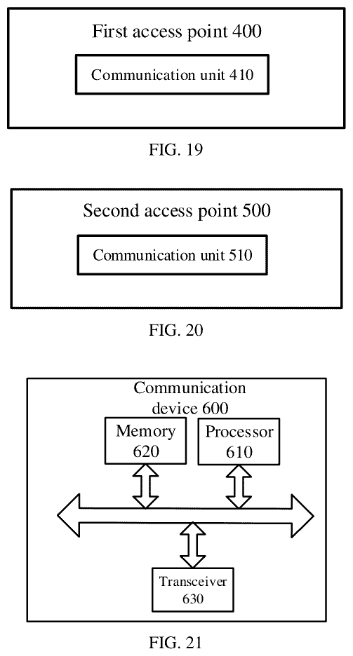

The method embodiments of the present disclosure are described in detail above in conjunction with FIG. 6 to FIG. 18, and apparatus embodiments of the present disclosure are described in detail below in conjunction with FIG. 19 to FIG. 23. It should be understood that the apparatus embodiments and the method embodiments correspond to each other, and similar descriptions may refer to the method embodiments.

FIG. 19 is a schematic block diagram of a first access point (AP) 400 according to the embodiments of the present disclosure. As shown in FIG. 19, the first AP 400 includes:

a communication unit 410, configured to transmit first information to at least one second AP, where the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the at least one second AP belong to the multi-AP coordinated set.

In some embodiments, the first information is used to indicate at least one of:
at least one AP, where the at least one AP includes an AP in the multi-AP coordinated set and participating in the multi-AP coordinated transmission in the C-BF mode, and/or an AP in the multi-AP coordinated set and not participating in the multi-AP coordinated transmission in the C-BF mode; or
at least one STA set, where each STA set corresponds to an AP participating in the multi-AP coordinated transmission in the C-BF mode, and the STA set includes an STA that participates in the multi-AP coordinated transmission in the C-BF mode among STAs associated with a corresponding AP, and/or an STA that does not participate in the multi-AP coordinated transmission in the C-BF mode among STAs associated with a corresponding AP.

In some embodiments, the at least one STA set is indicated by a bitmap.

In some embodiments, the first information includes:
at least one associated STA list, where each associated STA list corresponds to an AP participating in the multi-AP coordinated transmission in the C-BF mode, and each associated STA list is used to indicate STAs associated with a corresponding AP; and
at least one C-BF bitmap, where each C-BF bitmap corresponds to an AP participating in the multi-AP coordinated transmission in the C-BF mode, and each C-BF bitmap is used to indicate an STA participating in the multi-AP coordinated transmission in the C-BF mode or an STA not participating in the multi-AP coordinated transmission in the C-BF mode, in a list of STAs associated with a corresponding AP.

In some embodiments, the first information includes at least one STA list participating in C-BF, and each STA list participating in the C-BF corresponds to an AP participating in the multi-AP coordinated transmission in the C-BF mode, and the STA list participating in the C-BF is used to indicate STAs participating in the multi-AP coordinated transmission in the C-BF mode and associated with a corresponding AP.

In some embodiments, the first information further includes first indication information, and the first indication information is used to indicate the multi-AP coordinated transmission adopting the C-BF mode.

In some embodiments, the first information is carried in a first frame, the first frame includes a coordinated transmission announce field, and the coordinated transmission announce field is used to carry the first information.

In some embodiments, the coordinated transmission announce field includes at least one of the following fields:
a coordinated transmission (TX) scheme adopted field, to indicate a mode adopted to perform the multi-AP coordinated transmission;
a C-BF parameters field, to indicate parameters adopted to perform the multi-AP coordinated transmission in the C-BF mode;
a coordinated orthogonal frequency division multiple access (C-OFDMA) parameters field, to indicate parameters adopted to perform the multi-AP coordinated transmission in a C-OFDMA mode;
a coordinated spatial reuse (C-SR) parameters field, to indicate parameters adopted to perform the multi-AP coordinated transmission in a C-SR mode;
a joint transmission (J-TX) parameters field, to indicate parameters adopted to perform the multi-AP coordinated transmission in a J-TX mode; or
a coordinated uplink multiple user multiple input multiple output (C-UL MU MIMO) parameters field, to indicate parameters adopted to perform the multi-AP coordinated transmission in a C-UL MU MIMO mode.

In some embodiments, the C-BF parameters field includes at least one of the following fields:
a number of APs field, to indicate the number of APs included in the first frame;
at least one AP identification (ID) field, where each AP ID field indicates an AP participating in the multi-AP coordinated transmission in the C-BF mode and/or an AP not participating in the multi-AP coordinated transmission in the C-BF mode;
at least one associated STA list field, where each associated STA list field corresponds to an AP indicated by the at least one AP ID field, and the associated STA list field is used to indicate a list of STAs associated with a corresponding AP; or
at least one C-BF bitmap field, where each C-BF bitmap field corresponds to an AP indicated by the at least one AP ID field, and the C-BF bitmap field is used to indicate whether STAs in a list of STAs associated with a corresponding AP participate in the multi-AP coordinated transmission in the C-BF mode.

In some embodiments, the C-BF parameters field includes at least one of the following fields:
a number of APs field, to indicate the number of APs included in the first frame;
at least one AP ID field, to indicate at least one AP participating in the multi-AP coordinated transmission in the C-BF mode; or
at least one STA list participating in C-BF field, where each STA list participating in C-BF field corresponds to an AP indicated by the at least one AP ID field, and the STA list participating in C-BF field is used to indicate STAs associated with a corresponding AP and participating in the multi-AP coordinated transmission in the C-BF mode.

In some embodiments, the coordinated TX Scheme adopted field includes at least one of the following fields:
a C-BF adopted field, to indicate whether the multi-AP coordinated transmission in the C-BF mode is adopted;
a C-OFDMA adopted field, to indicate whether the multi-AP coordinated transmission in the C-OFDMA mode is adopted;
a C-SR adopted field, to indicate whether the multi-AP coordinated transmission in the C-SR mode is adopted;
a J-TX adopted field, to indicate whether the multi-AP coordinated transmission in the J-TX mode is adopted; or
a C-UL MU MIMO adopted field, to indicate whether the multi-AP coordinated transmission in the C-UL MU MIMO mode is adopted.

In some embodiments, the first frame is further used to trigger an AP participating in the multi-AP coordinated transmission in the C-BF mode to perform the multi-AP coordinated transmission in the C-BF mode.

In some embodiments, the communication unit 410 is further configured to:
transmit first request information to at least one third AP, where the first request information is used to request the at least one third AP to participate in the multi-AP coordinated transmission in the C-BF mode, and the at least one third AP belongs to the multi-AP coordinated set.

In some embodiments, the at least one third AP includes the at least one second AP.

In some embodiments, the first request information includes second indication information, and the second indication information is used to indicate a coordinated transmission mode in which the first AP requests to participate.

In some embodiments, the first request information is carried in a second frame, and the second frame includes a coordinated transmission request field, and the coordinated transmission request field is used to carry the first request information.

In some embodiments, the coordinated transmission request field includes at least one of the following fields:
a coordinated TX scheme used field, to indicate a coordinated transmission mode requested to be used;
a C-BF command field, to indicate a command used when the multi-AP coordinated transmission in the C-BF mode is adopted;
a C-OFDMA command field, to indicate a command used when the multi-AP coordinated transmission in a C-OFDMA mode is adopted;
a C-SR command field, to indicate a command used when the multi-AP coordinated transmission in a C-SR mode is adopted;
a J-TX command field, to indicate a command used when the multi-AP coordinated transmission in a J-TX mode is adopted; or
a C-UL MU MIMO command field, to indicate a command used when the multi-AP coordinated transmission in a C-UL MU MIMO mode is adopted.

In some embodiments, the coordinated TX Scheme used field includes at least one of the following fields:
a C-BF used field, to indicate whether to request to use the multi-AP coordinated transmission in the C-BF mode;
a C-OFDMA used field, to indicate whether to request to use the multi-AP coordinated transmission in the C-OFDMA mode;
a C-SR used field, to indicate whether to request to use the multi-AP coordinated transmission in the C-SR mode;
a J-TX used field, to indicate whether to request to use the multi-AP coordinated transmission in the J-TX mode; or
a C-UL MU MIMO used field, to indicate whether to request to use the multi-AP coordinated transmission in the C-UL MU MIMO mode.

In some embodiments, the communication unit 410 is exemplarily configured to:
transmit the first request information to the at least one third AP by broadcasting or multicasting; or
transmit the first request information to the at least one third AP by unicasting.

In some embodiments, the communication unit 410 is further configured to:

receive first response information transmitted by the at least one third AP, where the first response information is used to indicate whether the third AP participates in the multi-AP coordinated transmission in the C-BF mode and/or whether an STA associated with the third AP participates in the multi-AP coordinated transmission in the C-BF mode.

In some embodiments, the communication unit 410 is exemplarily configured to:
receive the first response information transmitted synchronously by the at least one third AP; or
receive the first response information transmitted asynchronously by the at least one third AP.

In some embodiments, the first response information includes an associated STA list and a C-BF bitmap, the associated STA list is a list of STAs associated with the third AP, and the C-BF bitmap is used to indicate whether each STA in the list of STAs associated with the third AP participates in the multi-AP coordinated transmission in the C-BF mode.

In some embodiments, the first response information includes an STA list participating in C-BF, and the STA list participating in the C-BF is a list of STAs associated with the third AP and participating in the multi-AP coordinated transmission in the C-BF mode.

In some embodiments, the first response information further includes third indication information, and the third indication information is used to indicate a coordinated transmission mode accepted by the third AP.

In some embodiments, the first response information is carried in a third frame, the third frame includes a coordinated transmission response field, and the coordinated transmission response field is used to carry the first response information.

In some embodiments, the coordinated transmission response field includes at least one of the following fields:
a coordinated TX scheme accept field, to indicate whether the third AP accepts a requested coordinated transmission mode;
a C-BF information field, to indicate information related to the third AP with C-BF;
a C-OFDMA information field, to indicate information related to the third AP with C-OFDMA;
a C-SR information field, to indicate information related to the third AP with C-SR;
a J-TX information field, to indicate information related to the third AP with J-TX; or
a C-UL MU MIMO information field, to indicate information related to the third AP with C-UL MU MIMO.

In some embodiments, the C-BF information field includes at least one of the following fields:
an associated STA list field, to indicate a list of STAs associated with the third AP; or
a C-BF bitmap of associated STAs field, to indicate whether each STA in the list of STAs associated with the third AP participates in the multi-AP coordinated transmission in the C-BF mode.

In some embodiments, the C-BF information field includes an STA list participating in C-BF field, which is used to indicate STAs associated with the third AP and participating in the multi-AP coordinated transmission in the C-BF mode.

In some embodiments, the coordinated TX Scheme accept field includes at least one of the following fields:
a C-BF accept field, to indicate whether the multi-AP coordinated transmission in a C-BF mode is accepted;
a C-OFDMA accept field, to indicate whether the multi-AP coordinated transmission in a C-OFDMA mode is accepted;
a C-SR accept field, to indicate whether the multi-AP coordinated transmission in a C-SR mode is accepted;
a J-TX accept field, to indicate whether the multi-AP coordinated transmission in a J-TX mode is accepted; or
a C-UL MU MIMO accept field, to indicate whether the coordinated transmission in a C-UL MU MIMO mode is accepted.

In some embodiments, the at least one second AP is an AP in the multi-AP coordinated set and participating in the multi-AP coordinated transmission in the C-BF mode.

In some embodiments, the first AP is a sharing AP, and the at least one second AP is a shared AP.

In some embodiments, the first AP is a master AP and the at least one second AP is a slave AP.

Optionally, in some embodiments, the communication unit described above may be a communication interface or a transceiver, or an input/output interface of a communication chip or a system on chip. The processing unit described above may be one or more processors.

It should be understood that the first AP 400 according to the embodiments of the present disclosure may correspond to the first AP or sharing AP in the method embodiments of the present disclosure, and the above and other operations and/or functions of each unit in the first AP 400 are respectively for implementing the corresponding processes of the first AP or sharing AP in the method 200 shown in FIG. 6 to FIG. 18, which will not be repeated here for the sake of brevity.

FIG. 20 is a schematic block diagram of a second access point (AP) according to the embodiments of the present disclosure. The second AP 500 of FIG. 5 includes:
a communication unit 510, configured to receive first information transmitted by a first AP, where the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the second AP belong to the multi-AP coordinated set.

In some embodiments, the first information is used to indicate at least one of:
at least one AP, where the at least one AP includes an AP in the multi-AP coordinated set and participating in the multi-AP coordinated transmission in the C-BF mode, and/or an AP in the multi-AP coordinated set and not participating in the multi-AP coordinated transmission in the C-BF mode; or
at least one STA set, where each STA set corresponds to an AP participating in the multi-AP coordinated transmission in the C-BF mode, and the STA set includes an STA that participates in the multi-AP coordinated transmission in the C-BF mode among STAs associated with a corresponding AP, and/or an STA that does not participate in the multi-AP coordinated transmission in the C-BF mode among STAs associated with a corresponding AP.

In some embodiments, the at least one STA set is indicated by a bitmap.

In some embodiments, the first information includes:
at least one associated STA list, where each associated STA list corresponds to an AP participating in the multi-AP coordinated transmission in the C-BF mode, and each associated STA list is used to indicate STAs associated with a corresponding AP; and
at least one C-BF bitmap, where each C-BF bitmap corresponds to an AP participating in the multi-AP coordinated transmission in the C-BF mode, and each C-BF bitmap is used to indicate an STA participating in the multi-AP coordinated transmission in the C-BF mode or an STA not participating in the multi-AP coordinated transmission in the C-BF mode, in a list of STAs associated with a corresponding AP.

In some embodiments, the first information includes at least one STA list participating in C-BF, and each STA list participating in the C-BF corresponds to an AP participating in the multi-AP coordinated transmission in the C-BF mode, and the STA list participating in the C-BF is used to indicate STAs participating in the multi-AP coordinated transmission in the C-BF mode and associated with a corresponding AP.

In some embodiments, the first information further includes first indication information, and the first indication information is used to indicate the multi-AP coordinated transmission adopting the C-BF mode.

In some embodiments, the first information is carried in a first frame, the first frame includes a coordinated transmission announce field, and the coordinated transmission announce field is used to carry the first information.

In some embodiments, the coordinated transmission announce field includes at least one of the following fields:
a coordinated transmission (TX) scheme adopted field, to indicate a mode adopted to perform the multi-AP coordinated transmission;
a C-BF parameters field, to indicate parameters adopted to perform the multi-AP coordinated transmission in the C-BF mode;
a coordinated orthogonal frequency division multiple access (C-OFDMA) parameters field, to indicate parameters adopted to perform the multi-AP coordinated transmission in a C-OFDMA mode;
a coordinated spatial reuse (C-SR) parameters field, to indicate parameters adopted to perform the multi-AP coordinated transmission in a C-SR mode;
a joint transmission (J-TX) parameters field, to indicate parameters adopted to perform the multi-AP coordinated transmission in a J-TX mode; or a coordinated uplink multiple user multiple input multiple output (C-UL MU MIMO) parameters field, to indicate parameters adopted to perform the multi-AP coordinated transmission in a C-UL MU MIMO mode.

In some embodiments, the C-BF parameters field includes at least one of the following fields:
a number of APs field, to indicate the number of APs included in the first frame;
at least one AP identification (ID) field, where each AP ID field indicates an AP participating in the multi-AP coordinated transmission in the C-BF mode and/or an AP not participating in the multi-AP coordinated transmission in the C-BF mode;
at least one associated STA list field, where each associated STA list field corresponds to an AP indicated by the at least one AP ID field, and the associated STA list field is used to indicate a list of STAs associated with a corresponding AP; or
at least one C-BF bitmap field, where each C-BF bitmap field corresponds to an AP indicated by the at least one AP ID field, and the C-BF bitmap field is used to indicate whether STAs in a list of STAs associated with a corresponding AP participate in the multi-AP coordinated transmission in the C-BF mode.

In some embodiments, the C-BF parameters field includes at least one of the following fields:
a number of APs field, to indicate the number of APs included in the first frame;
at least one AP ID field, to indicate at least one AP participating in the multi-AP coordinated transmission in the C-BF mode; or
at least one STA list participating in C-BF field, where each STA list participating in C-BF field corresponds to an AP indicated by the at least one AP ID field, and the STA list participating in C-BF field is used to indicate STAs associated with a corresponding AP and participating in the multi-AP coordinated transmission in the C-BF mode.

In some embodiments, the coordinated TX Scheme adopted field includes at least one of the following fields:
a C-BF adopted field, to indicate whether the multi-AP coordinated transmission in the C-BF mode is adopted;
a C-OFDMA adopted field, to indicate whether the multi-AP coordinated transmission in the C-OFDMA mode is adopted;
a C-SR adopted field, to indicate whether the multi-AP coordinated transmission in the C-SR mode is adopted;
a J-TX adopted field, to indicate whether the multi-AP coordinated transmission in the J-TX mode is adopted; or
a C-UL MU MIMO adopted field, to indicate whether the multi-AP coordinated transmission in the C-UL MU MIMO mode is adopted.

In some embodiments, the first frame is further used to trigger an AP participating in the multi-AP coordinated transmission in the C-BF mode to perform the multi-AP coordinated transmission in the C-BF mode.

In some embodiments, the communication unit 510 is further configured to:
receive first request information transmitted by the first AP, where the first request information is used to request the second AP to participate in the multi-AP coordinated transmission in the C-BF mode.

In some embodiments, the first request information includes second indication information, and the second indication information is used to indicate a coordinated transmission mode in which the first AP requests to participate.

In some embodiments, the first request information is carried in a second frame, and the second frame includes a coordinated transmission request field, and the coordinated transmission request field is used to carry the first request information.

In some embodiments, the coordinated transmission request field includes at least one of the following fields:
a coordinated TX scheme used field, to indicate a coordinated transmission mode requested to be used;
a C-BF command field, to indicate a command used when the multi-AP coordinated transmission in the C-BF mode is adopted;
a C-OFDMA command field, to indicate a command used when the multi-AP coordinated transmission in a C-OFDMA mode is adopted;
a C-SR command field, to indicate a command used when the multi-AP coordinated transmission in a C-SR mode is adopted;
a J-TX command field, to indicate a command used when the multi-AP coordinated transmission in a J-TX mode is adopted; or
a C-UL MU MIMO command field, to indicate a command used when the multi-AP coordinated transmission in a C-UL MU MIMO mode is adopted.

In some embodiments, the coordinated TX Scheme used field includes at least one of the following fields:
a C-BF used field, to indicate whether to request to use the multi-AP coordinated transmission in the C-BF mode;
a C-OFDMA used field, to indicate whether to request to use the multi-AP coordinated transmission in the C-OFDMA mode;
a C-SR used field, to indicate whether to request to use the multi-AP coordinated transmission in the C-SR mode;
a J-TX used field, to indicate whether to request to use the multi-AP coordinated transmission in the J-TX mode; or
a C-UL MU MIMO used field, to indicate whether to request to use the multi-AP coordinated transmission in the C-UL MU MIMO mode.

In some other embodiments, the communication unit 510 is exemplarily configured to:
receive the first request information transmitted by the first AP by broadcasting or multicasting; or
receive the first request information transmitted by the first AP by unicasting.

In some other embodiments, the communication unit 510 is further configured to:
transmit first response information to the first AP, where the first response information is used to indicate whether the second AP participates in the multi-AP coordinated transmission in the C-BF mode and/or whether an STA associated with the second AP participates in the multi-AP coordinated transmission in the C-BF mode.

In some embodiments, the first response information includes an associated STA list and a C-BF bitmap, the associated STA list is a list of STAs associated with the second AP, and the C-BF bitmap is used to indicate whether each STA in the list of STAs associated with the second AP participates in the multi-AP coordinated transmission in the C-BF mode.

In some embodiments, the first response information includes an STA list participating in C-BF, and the STA list participating in the C-BF is a list of STAs associated with the second AP and participating in the multi-AP coordinated transmission in the C-BF mode.

In some embodiments, the first response information further includes third indication information, and the third indication information is used to indicate a coordinated transmission mode accepted by the second AP.

In some embodiments, the first response information is carried in a third frame, the third frame includes a coordinated transmission response field, and the coordinated transmission response field is used to carry the first response information.

In some embodiments, the coordinated transmission response field includes at least one of the following fields:
a coordinated TX scheme accept field, to indicate a coordinated transmission mode accepted by the second AP;
a C-BF information field, to indicate information related to the second AP with C-BF;
a C-OFDMA information field, to indicate information related to the second AP with C-OFDMA;
a C-SR information field, to indicate information related to the second AP with C-SR;
a J-TX information field, to indicate information related to the second AP with J-TX; or
a C-UL MU MIMO information field, to indicate information related to the second AP with C-UL MU MIMO.

In some embodiments, the C-BF information field includes at least one of the following fields:
an associated STA list field, to indicate a list of STAs associated with the second AP; or
a C-BF bitmap of associated STAs field, to indicate whether each STA in the list of STAs associated with the second AP participates in the multi-AP coordinated transmission in the C-BF mode.

In some embodiments, the C-BF information field includes an STA list participating in C-BF field, which is used to indicate STAs associated with the second AP and participating in the multi-AP coordinated transmission in the C-BF mode.

In some embodiments, the coordinated TX Scheme accept field includes at least one of the following fields:
a C-BF accept field, to indicate whether the multi-AP coordinated transmission in a C-BF mode is accepted;
a C-OFDMA accept field, to indicate whether the multi-AP coordinated transmission in a C-OFDMA mode is accepted;
a C-SR accept field, to indicate whether the multi-AP coordinated transmission in a C-SR mode is accepted;
a J-TX accept field, to indicate whether the multi-AP coordinated transmission in a J-TX mode is accepted; or
a C-UL MU MIMO accept field, to indicate whether the coordinated transmission in a C-UL MU MIMO mode is accepted.

In some embodiments, the second AP further includes:
a processing unit, configured to determine target channel state information among pre-stored channel state information according to the first information; and
calculate a steering matrix for the multi-AP coordinated transmission in the C-BF mode according to the target channel state information.

In some embodiments, the processing unit is exemplarily configured to:
eliminate the following channel state information among the pre-stored channel state information according to the first information, to obtain the target channel state information:
channel state information between the second AP and a second-type STA associated with the second AP; and
channel state information between the second AP and an STA associated with a second-type AP;
where the second-type STA is an STA that does not participate in the multi-AP coordinated transmission in C-BF, and the second-type AP is an AP that does not participate in the multi-AP coordinated transmission in C-BF.

In some embodiments, the communication unit 510 is further configured to:
transmit, by using the steering matrix, data to an STA associated with the second AP and participating in the multi-AP coordinated transmission in C-BF.

In some embodiments, the pre-stored channel state information is obtained by the second AP during a channel sounding phase.

In some embodiments, the second AP is an AP in the multi-AP coordinated set and participating in the multi-AP coordinated transmission in the C-BF mode.

In some embodiments, the first AP is a sharing AP, and the second AP is a shared AP.

In some embodiments, the first AP is a master AP and the second AP is a slave AP.

Optionally, in some embodiments, the communication unit described above may be a communication interface or a transceiver, or an input/output interface of a communication chip or a system on chip. The processing unit described above may be one or more processors.

It should be understood that the second AP 500 according to the embodiments of the present disclosure may correspond to the second AP or shared AP in the method embodiments of the present disclosure, and the above and other operations and/or functions of each unit in the second AP 500 are respectively for implementing the corresponding processes of the second AP or shared AP in the method 200 shown in FIG. 6 to FIG. 18, which will not be repeated here for the sake of brevity.

FIG. 21 is a schematic structure diagram of a communication device 600, provided in the embodiments of the present disclosure. The communication device 600 shown in FIG. 21 includes a processor 610, the processor 610 may invoke and execute a computer program from a memory to implement the method in the embodiments of the present disclosure.

Optionally, as shown in FIG. 21, the communication device 600 may further include a memory 620. Herein, the processor 610 may invoke and execute a computer program from the memory 620 to implement the method in the embodiments of the present disclosure.

Herein, the memory 620 may be a separate device independent from the processor 610, or may also be integrated into the processor 610.

Optionally, as shown in FIG. 21, the communication device 600 may further include a transceiver 630, and the processor 610 may control the transceiver 630 to communicate with other devices, exemplarily, to transmit information or data to other devices, or receive information or data transmitted by other devices.

Herein, the transceiver 630 may include a transmitter and a receiver. The transceiver 630 may further include antenna(s), and the number of the antenna(s) may be one or more.

Optionally, the communication device 600 may exemplarily be the first AP or sharing AP in the embodiments of the present disclosure, and the communication device 600 may implement the corresponding processes implemented by the first AP or sharing AP in various methods of the embodiments of the present disclosure, which will not be repeated here, for the sake of brevity.

Optionally, the communication device 600 may exemplarily be the second AP or shared AP in the embodiments of the present disclosure, and the communication device 600 may implement the corresponding processes implemented by the second AP or shared AP in various methods of the embodiments of the present disclosure, which will not be repeated here, for the sake of brevity.

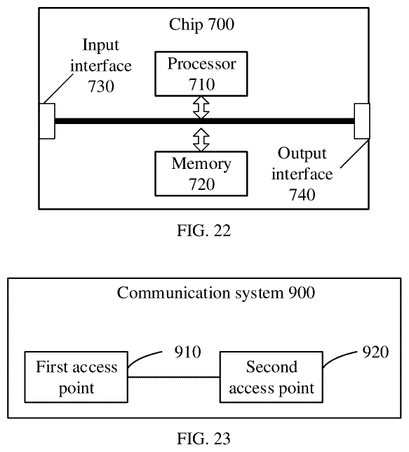

FIG. 22 is a schematic structural diagram of a chip of the embodiments of the present disclosure. The chip 700 shown in FIG. 22 includes a processor 710, the processor 710 may invoke and execute a computer program from a memory to implement the method in the embodiments of the present disclosure.

Optionally, as shown in FIG. 22, the chip 700 may further include a memory 720. Herein, the processor 710 may invoke and execute a computer program from the memory 720 to implement the method in the embodiments of the present disclosure.

Herein, the memory 720 may be a separate device independent from the processor 710, or may also be integrated into the processor 710.

Optionally, the chip 700 may further include an input interface 730. Herein, the processor 710 may control the input interface 730 to communicate with other devices or chips, and exemplarily, the input interface 730 may acquire information or data sent by other devices or chips.

Optionally, the chip 700 may further include an output interface 740. Herein, the processor 710 may control the output interface 740 to communicate with other devices or chips, and exemplarily, the output interface 740 may output information or data to other devices or chips.

Optionally, the chip may be applied to the first AP or sharing AP in the embodiments of the present disclosure, and the chip may implement the corresponding procedure implemented by the first AP or sharing AP in the various methods of the embodiments of the present disclosure, which will not be repeated here for the sake of brevity.

Optionally, the chip may be applied to the second AP or shared AP in the embodiments of the present disclosure, and the chip may implement the corresponding procedure implemented by the second AP or shared AP in the various methods of the embodiments of the present disclosure, which will not be repeated here for the sake of brevity.

It should be understood that the chip mentioned in the embodiments of the present disclosure may also be referred to as a system on chip, a system chip, a chip system or a system-on-chip chip, etc.

FIG. 23 is a schematic block diagram of a communication system 900, provided in the embodiments of the present disclosure. As shown in FIG. 23, the communication system 900 includes a first access point 910 and a second access point 920.

Herein, the first access point 910 may be used to implement the corresponding functions implemented by the first AP or sharing AP in the above method, and the second access point 920 may be used to implement the corresponding functions implemented by the second AP or shared AP in the above method, which will not be repeated here for the sake of brevity.

It should be understood that the processor in the embodiments of the present disclosure may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that the memory in the embodiments of the present disclosure may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present disclosure is intended to include, but not limited to, these and any other suitable types of memories.

The embodiments of the present disclosure further provide a computer readable storage medium for storing a computer program.

Optionally, the computer readable storage medium may be applied to the first AP or sharing AP in the embodiments of the present disclosure, and the computer program causes a computer to perform the corresponding procedure implemented by the first AP or sharing AP in the various methods of the embodiments of the present disclosure, which will not be repeated here for the sake of brevity.

Optionally, the computer readable storage medium may be applied to the second AP or shared AP in the embodiments of the present disclosure, and the computer program causes a computer to perform the corresponding procedure implemented by the second AP or shared AP in various methods of the embodiments of the present disclosure, which will not be repeated here for the sake of brevity.

The embodiments of the present disclosure further provide a computer program product including a computer program instruction.

Optionally, the computer program product may be applied to the first AP or sharing AP in the embodiments of the present disclosure, and the computer program instruction causes a computer to perform the corresponding procedure implemented by the first AP or sharing AP in the various methods of the embodiments of the present disclosure, which will not be repeated here for the sake of brevity.

Optionally, the computer program product may be applied to the second AP or shared AP in the embodiments of the present disclosure, and the computer program instruction causes a computer to perform the corresponding procedure implemented by the second AP or shared AP in various methods of the embodiments of the present disclosure, which will not be repeated here for the sake of brevity.

The embodiments of the present disclosure further provide a computer program.

Optionally, the computer program may be applied to the first AP or sharing AP in the embodiments of the present disclosure, the computer program when being executed on a computer, causes the computer to perform the corresponding procedure implemented by the first AP or sharing AP in various methods of the embodiments of the present disclosure, which will not be repeated here for the sake of brevity.

Optionally, the computer program may be applied to the second AP or shared AP in the embodiments of the present disclosure, the computer program when being executed on a computer, causes the computer to perform the corresponding procedure implemented by the second AP or shared AP in various methods of the embodiments of the present disclosure, which will not be repeated here for the sake of brevity.

Those ordinary skilled in the art may realize that, units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present disclosure.

It may be clearly understood by those skilled in the art that, for convenience and brevity of the description, the specific working procedures of the system, the apparatus and the unit described above may refer to the corresponding procedures in the above method embodiments, which will not be repeated here.

In the several embodiments provided by the disclosure, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

If the described functions are implemented in a form of a software functional unit and sold or used as an independent product, they may be stored in a computer readable storage medium. Based on this understanding, the technical solution of the present disclosure essentially, or a part of the technical solution that contributes to the prior art, or a part of the technical solution, may be embodied in a form of a software product, and the computer software product is stored in a storage medium, and includes a plurality of instructions for enabling a computer device (which may be a personal computer, a server, or a network device, etc.) to perform all or some of steps of the methods described in the various embodiments of the present disclosure. And, the storage medium mentioned above includes a USB flash drive (U disk), a mobile hard disk, a Read-Only Memory (ROM), a Random Access Memory (RAM), a diskette, or an optical disk, and various mediums that may store program codes.

The above content is only specific implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A method of wireless communication, comprising:
transmitting, by a first access point (AP), first information to at least one second AP, wherein the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the at least one second AP belong to the multi-AP coordinated set.

2. The method according to claim 1, wherein the first information is used to indicate at least one of:
at least one AP, wherein the at least one AP comprises an AP in the multi-AP coordinated set and participating in the multi-AP coordinated transmission in the C-BF mode, and/or an AP in the multi-AP coordinated set and not participating in the multi-AP coordinated transmission in the C-BF mode; or
at least one STA set, wherein each STA set corresponds to an AP participating in the multi-AP coordinated transmission in the C-BF mode, and each STA set comprises STAs that participate in the multi-AP coordinated transmission in the C-BF mode among STAs associated with a corresponding AP, and/or STAs that do not participate in the multi-AP coordinated transmission in the C-BF mode among STAs associated with a corresponding AP;
wherein the at least one STA set is indicated by a bitmap.

3. The method according to claim 2, wherein the first information comprises:
at least one associated STA list, wherein each associated STA list corresponds to an AP participating in the multi-AP coordinated transmission in the C-BF mode, and each associated STA list is used to indicate a list of STAs associated with a corresponding AP; and
at least one C-BF bitmap, wherein each C-BF bitmap corresponds to an AP participating in the multi-AP coordinated transmission in the C-BF mode, and each C-BF bitmap is used to indicate STAs participating in the multi-AP coordinated transmission in the C-BF mode and/or STAs not participating in the multi-AP coordinated transmission in the C-BF mode, in a list of STAs associated with a corresponding AP.

4. The method according to claim 2, wherein the first information comprises at least one STA list participating in C-BF, each STA list participating in the C-BF corresponds to an AP participating in the multi-AP coordinated transmission in the C-BF mode, and the STA list participating in the C-BF is used to indicate STAs participating in the multi-AP coordinated transmission in the C-BF mode and associated with a corresponding AP.

5. The method according to claim 1, wherein the first information further comprises first indication information, and the first indication information is used to indicate the multi-AP coordinated transmission adopting the C-BF mode.

6. The method according to claim 1, wherein the method further comprises:
transmitting, by the first AP, first request information to at least one third AP, wherein the first request information is used to request the at least one third AP to participate in the multi-AP coordinated transmission in the C-BF mode, and the at least one third AP belongs to the multi-AP coordinated set.

7. The method according to claim 6, wherein the method further comprises:
receiving, by the first AP, first response information transmitted by the at least one third AP, wherein the first response information is used to indicate whether the third AP participates in the multi-AP coordinated transmission in the C-BF mode and/or whether a STA associated with the third AP participates in the multi-AP coordinated transmission in the C-BF mode.

8. The method according to claim 7, wherein the first response information comprises an associated STA list and a C-BF bitmap, the associated STA list is a list of STAs associated with the third AP, and the C-BF bitmap is used to indicate whether each STA in the list of STAs associated with the third AP participates in the multi-AP coordinated transmission in the C-BF mode.

9. The method according to claim 7, wherein the first response information comprises an STA list participating in C-BF, and the STA list participating in the C-BF is a list of STAs associated with the third AP and participating in the multi-AP coordinated transmission in the C-BF mode.

10. The method according to claim 7, wherein the first response information further comprises third indication information, and the third indication information is used to indicate a coordinated transmission mode accepted by the third AP.

11. A method of wireless communication, comprising:
receiving, by a second access point (AP), first information transmitted by a first AP, wherein the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the second AP belong to the multi-AP coordinated set.

12. The method according to claim 11, wherein the first information is used to indicate at least one of:
at least one AP, wherein the at least one AP comprises an AP in the multi-AP coordinated set and participating in the multi-AP coordinated transmission in the C-BF mode, and/or an AP in the multi-AP coordinated set and not participating in the multi-AP coordinated transmission in the C-BF mode; or
at least one STA set, wherein each STA set corresponds to an AP participating in the multi-AP coordinated transmission in the C-BF mode, and each STA set comprises STAs that participate in the multi-AP coordinated transmission in the C-BF mode among STAs associated with a corresponding AP, and/or STAs that do not participate in the multi-AP coordinated transmission in the C-BF mode among STAs associated with a corresponding AP;
wherein the at least one STA set is indicated by a bitmap.

13. The method according to claim 12, wherein the first information comprises:
at least one associated STA list, wherein each associated STA list corresponds to an AP participating in the multi-AP coordinated transmission in the C-BF mode, and each associated STA list is used to indicate a list of STAs associated with a corresponding AP; and
at least one C-BF bitmap, wherein each C-BF bitmap corresponds to an AP participating in the multi-AP coordinated transmission in the C-BF mode, and each C-BF bitmap is used to indicate STAs participating in the multi-AP coordinated transmission in the C-BF mode and/or STAs not participating in the multi-AP coordinated transmission in the C-BF mode, in a list of STAs associated with a corresponding AP.

14. The method according to claim 12, wherein the first information comprises at least one STA list participating in C-BF, each STA list participating in the C-BF corresponds to an AP participating in the multi-AP coordinated transmission in the C-BF mode, and the STA list participating in the C-BF is used to indicate STAs participating in the multi-AP coordinated transmission in the C-BF mode and associated with a corresponding AP.

15. The method according to claim 11, wherein the first information further comprises first indication information, and the first indication information is used to indicate the multi-AP coordinated transmission adopting the C-BF mode.

16. The method according to claim 11, wherein the method further comprises:
receiving, by the second AP, first request information transmitted by the first AP, wherein the first request information is used to request the second AP to participate in the multi-AP coordinated transmission in the C-BF mode.

17. The method according to claim 16, wherein the method further comprises:
transmitting, by the second AP, first response information to the first AP, wherein the first response information is used to indicate whether the second AP participates in the multi-AP coordinated transmission in the C-BF mode and/or whether an STA associated with the second AP participates in the multi-AP coordinated transmission in the C-BF mode.

18. The method according to claim 17, wherein the first response information comprises an associated STA list and a C-BF bitmap, the associated STA list is a list of STAs associated with the second AP, and the C-BF bitmap is used to indicate whether each STA in the list of STAs associated with the second AP participates in the multi-AP coordinated transmission in the C-BF mode; and/or
the first response information comprises an STA list participating in C-BF, and the STA list participating in the C-BF is a list of STAs associated with the second AP and participating in the multi-AP coordinated transmission in the C-BF mode.

19. The method according to claim 17, wherein the first response information further comprises third indication information, and the third indication information is used to indicate a coordinated transmission mode accepted by the second AP.

20. A first access point (AP), comprising: a processor and a memory, wherein the memory is configured to store a computer program, the processor is configured to invoke and execute the computer program stored in the memory, to cause the first AP to perform:
transmitting first information to at least one second AP, wherein the first information is used to indicate participation of an AP of a multi-AP coordinated set in a multi-AP coordinated transmission in a coordinated beamforming (C-BF) mode and/or participation of a station (STA) associated with an AP of the multi-AP coordinated set in the multi-AP coordinated transmission in the C-BF mode, and the first AP and the at least one second AP belong to the multi-AP coordinated set.
